(19) United States
(12) Patent Application Publication
(10) Pub. No.: US 2026/0193537 A1
(43) Pub. Date: Jul. 9, 2026

(54) POLYMERIZABLE COMPOUND, LIQUID CRYSTAL COMPOSITION COMPRISING SAME AND LIQUID CRYSTAL DISPLAY DEVICE

(71) Applicant: SHIJIAZHUANG CHENGZHI YONGHUA DISPLAY MATERIAL CO., LTD., Shijiazhuang (CN)

(72) Inventors: Hubo ZHANG, Shijiazhuang (CN); Xin WANG, Shijiazhuang (CN); Pengyao JU, Shijiazhuang (CN); Yongfeng BAO, Shijiazhuang (CN); Renze ZHANG, Shijiazhuang (CN); Ming LI, Shijiazhuang (CN); Jun JIANG, Shijiazhuang (CN); Liangjie ZHANG, Shijiazhuang (CN)

(73) Assignee: SHIJIAZHUANG CHENGZHI YONGHUA DISPLAY MATERIAL CO., LTD., Shijiazhuang (CN)

(21) Appl. No.: 19/429,186

(22) Filed: Dec. 22, 2025

(30) Foreign Application Priority Data
Jan. 7, 2025 (CN) 202510021989.2

(51) Int. Cl. C09K 19/34; C09K 19/32; C09K 19/56

(52) U.S. Cl. CPC C09K 19/3405; C09K 19/32; C09K 19/56; C09K 2019/3408

(57) ABSTRACT

The present invention discloses a polymerizable compound, a liquid crystal composition comprising the polymerizable compound, and a liquid crystal display device. The polymerizable compound is a compound represented by the following formula I, wherein Sp represents a single bond or a C1-C5 linear, branched or cyclic alkyl group, and the Sp groups are not both single bonds, wherein any one or more non-adjacent —CH₂— can be replaced by —O—, —S—, —CO—, —CH₂O—, —OCH₂—, —COO—, —OOC—, or an acrylate group in such a manner that O- or S-atoms are not directly connected with each other, one or more H atoms can be independently replaced by F, C1, or G3, and at least one H atom is replaced by G3; G3 represents a C1-C7 tertiary alcohol structure; and X represents —CH₂—, —O—, or —S—. In particular, the polymerizable compound has the advantages of good diffusivity, high stability of the formed polymer, and low residue after a UV process. It can be ensured that a display exhibits excellent IS performance under extreme conditions.

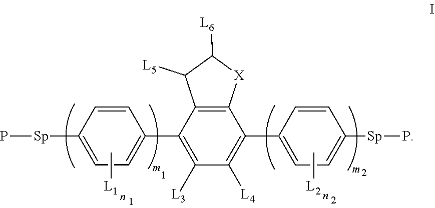

### TECHNICAL FIELD

The present invention relates to the field of liquid crystal display. More particularly, the present invention relates to a polymerizable compound, a liquid crystal composition comprising the polymerizable compound, and a liquid crystal display device.

### BACKGROUND ART

In recent years, with the continuous progress and development of science and technology, liquid crystal display technology (Liquid Crystal Display, LCD) has attracted great attention. Compared with traditional display technology, TFT-LCD liquid crystal display not only has many advantages such as small size, light weight, low power consumption and easy driving, but can also effectively make up for shortcomings of traditional display technology, and is widely used in various consumer electronic products such as mobile phones, televisions, digital cameras, laptops, and desktop computers.

For early commercial TFT-LCD products, a TN display mode is basically used, and the biggest challenge thereof is a narrow viewing angle. With the increase of the product size, especially in the field of TVs, IPS and VA display modes having wide viewing angle characteristics have been successively developed and applied. In particular, breakthrough advancements based on improvements to the VA display mode have been achieved by various leading companies in succession. This mainly depends on the inherent advantages of the VA mode, such as wide viewing angles, high contrast ratios, and no need for rubbing alignment. Furthermore, the contrast ratio of the VA display mode is less dependent on the optical anisotropy (Δn) of liquid crystals, the thickness (d) of liquid crystal cells, and the wavelength (A) of incident light. This will undoubtedly make the VA mode a very promising display technology.

However, liquid crystal media used in active matrix addressed display elements such as those with the VA mode have inherent imperfections, such as a significantly worse image sticking level than that of positive-dielectric-anisotropy display elements, a relatively slow response time, and a relatively high driving voltage. In addition, some new VA display technologies have quietly emerged. For example, PSVA (polymer stabilized vertically aligned) technology not only achieves a wide viewing angle display mode similar to MVA/PVA, but also simplifies a CF process, thus reducing CF costs while improving the aperture ratio, and higher brightness and thus higher contrast ratio can also be obtained. In addition, compared with other common liquid crystal modes (such as TN mode and IPS mode), display devices with the PSVA mode also have the advantages of good dark state, fast response speed, high transmittance, etc., and they are widely used in many scenes; however, the use thereof is still currently restricted in some fields, such as petroleum, chemical engineering, coal and other industries, in which the production environment often has problems such as high temperature and high humidity, and existing PSVA display screens cannot work stably in such environments. Still for example, in the field of outdoor display screens, when PSVA display screens are used for displaying information such as commercial advertisements, traffic guidance, city signs, and sports events, they are prone to image sticking problems due to various harsh weather conditions. As an important constituent of PSVA, a reactive monomer (RM, also referred to as a polymerizable compound) is the main cause that restricts the above-mentioned use. In these extreme environments, such as high temperature, low temperature, high- and low-temperature cycling, high temperature and high humidity, a polymer formed from the RM may show stability problems, further affecting the display effect thereof.

The residue of the RM needs to be further reduced. Another problem in the production of PSVA displays is the presence or removal of residual unpolymerized RMs, especially after a polymerization step for generating a pretilt angle in the displays. For example, such unreacted RMs may adversely affect the performance of the display by, for example, polymerization in an uncontrolled manner during operation after the display is manufactured. There is an urgent need for an RM monomer exhibiting low residue after a UV process.

The diffusivity of RM needs to be further improved. For RM monomers, due to corporate demands for cost reduction and efficiency improvement, it is generally expected that the polymerization thereof is as fast as possible in terms of rate and controllable. However, if the diffusivity thereof is relatively poor, runaway polymerization easily occurs to form Zara Particle, which in turn affects the display effect of a panel. SAVA (Self-Alignment for Vertical Alignment) displays have no conventional polyimide alignment films due to the use of so-called self-aligning additives for vertical alignment. Liquid crystal media involved in such displays generally comprise low-molecular-weight liquid crystal components, self-aligning agents containing polar anchoring groups, and polymerizable components (RM). Using this RM component can stabilize the orientation of the liquid crystal medium and optionally establish the desired “pretilt”. In order to make the final display panel exhibit good display, self-aligning additives and RMs need to be quickly and uniformly dispersed on a substrate after dropping by an ODF (One Drop Filling) process, so as to realize low concentration difference of monomers across different panel regions and avoid poor alignment effects or Zara Particle formation in peripheral and corner areas of the panel, resulting in poor display. Both of the modes put forward higher requirements for the diffusivity of RMs.

### SUMMARY OF THE INVENTION

On this basis, an objective of the present invention is to provide a liquid crystal composition and a liquid crystal display device comprising the liquid crystal composition, so as to at least solve the above technical problems. In the molecular structure of the polymerizable compound provided by the present invention, specifically by incorporating a fused ring system into a tertiary-alcohol-branch-containing polymerizable compound structure having biphenyl or terphenyl in which phenyl rings are directly linked, the molecular spatial structure and polymerization properties thereof are improved, thereby eliminating the above disadvantages (in extreme environments, the polymer formed from the RM shows low stability, large RM residue, and slightly worse diffusivity of the RM) or reducing the degree of the above disadvantages. In particular, the polymerizable compound has the advantages of good diffusivity, high stability of the formed polymer, and low residue after a UV process. In addition, after the liquid crystal composition formed by the combination of the polymerizable compound and the liquid crystal component is applied to a liquid crystal display, it can be ensured that the IS performance of the display is excellent under extreme conditions (high temperature, low temperature, high- and low-temperature cycling, and high temperature and high humidity), and the risk of problems such as image sticking on the final display is reduced.

In order to achieve the above objective, the following technical solution is used in the present invention:

In one aspect, the present invention provides a polymerizable compound. The polymerizable compound is a compound represented by the following formula I:

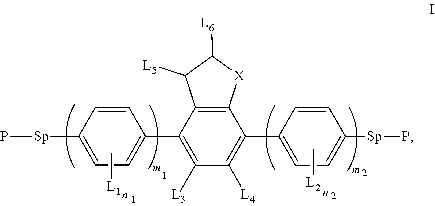

wherein
L₁ and L₂ are each independently selected from H, C1-C5 alkyl or alkoxy, C2-C5 alkenyl or alkenoxy, fluorine-substituted C1-C5 alkyl or alkoxy, fluorine-substituted C2-C5 alkenyl or alkenoxy, and halogen, wherein any one or more non-adjacent —CH₂— can be each independently replaced by —O—, —S—, —CO—, —CH₂O—, —OCH₂—, —COO—, —OOC—, or —Sp—;
L₃, L₄, L₅, and L₆ are each independently selected from H, C1-C5 alkyl or alkoxy, C2-C5 alkenyl or alkenoxy, fluorine-substituted C1-C5 alkyl or alkoxy, fluorine-substituted C2-C5 alkenyl or alkenoxy, and halogen;
n₁ and n₂ each independently represent 0, 1, 2, 3, or 4;
m₁ and m₂ each independently represent 0 or 1, and m₁ and m₂ are not both 0;
each occurrence of P independently represents an acrylate group, a methacrylate group, or a fluoroacrylate group;
Sp represents a single bond or a C1-C5 linear, branched or cyclic alkyl group, and the Sp groups are not both single bonds, wherein any one or more non-adjacent —CH₂— can be replaced by —O—, —S—, —CO—, —CH₂O—, —OCH₂—, —COO—, —OOC—, or an acrylate group in such a manner that O- or S-atoms are not directly connected with each other, one or more H atoms can be independently replaced by F, Cl, or G3, and at least one H atom is replaced by G3;
G3 represents a C1-C7 tertiary alcohol structure; and
X represents —CH₂—, —O—, or —S—.

Furthermore, the compound represented by formula I is at least one of compounds represented by formulas I-1 to I-41:

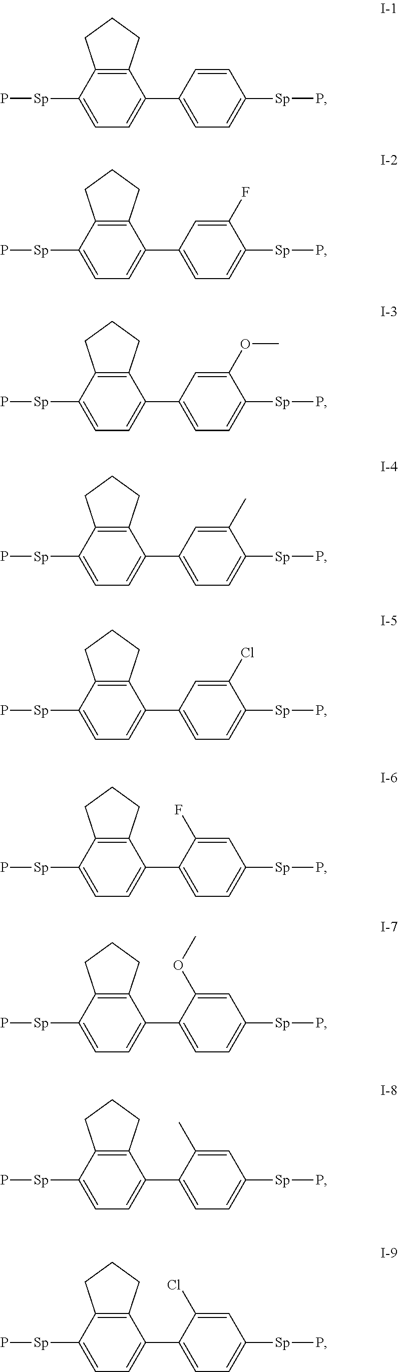

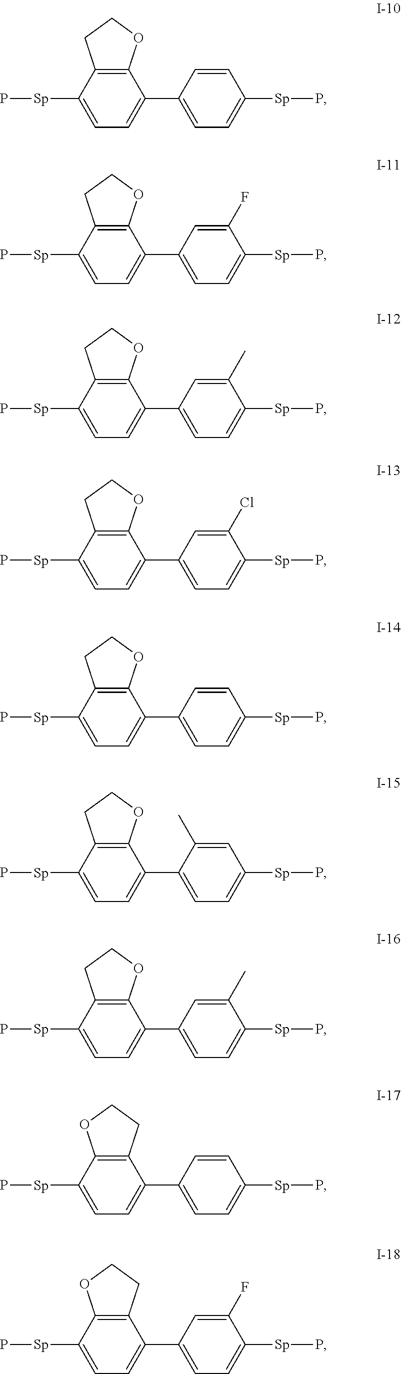

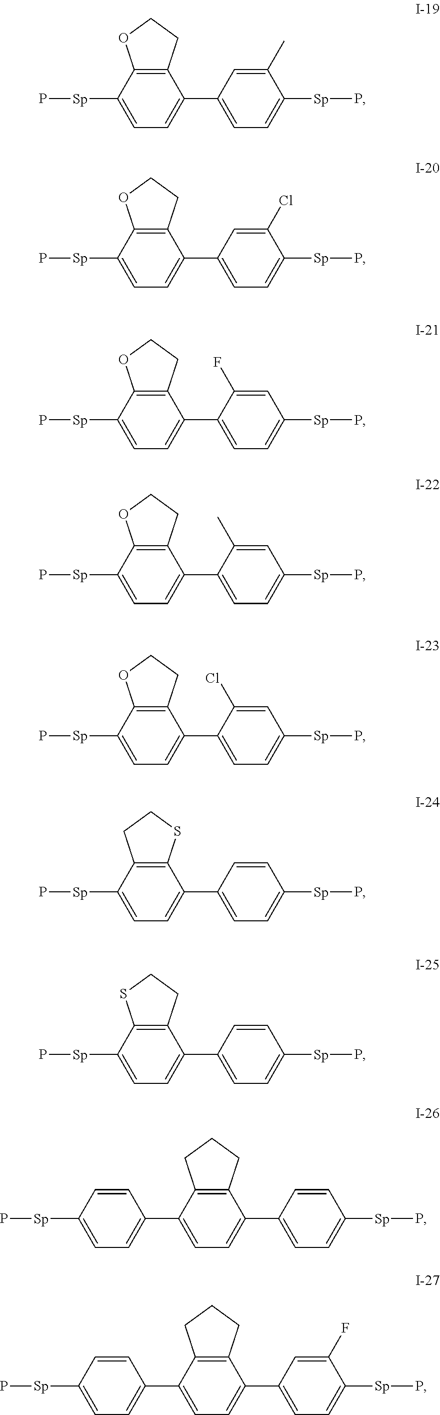

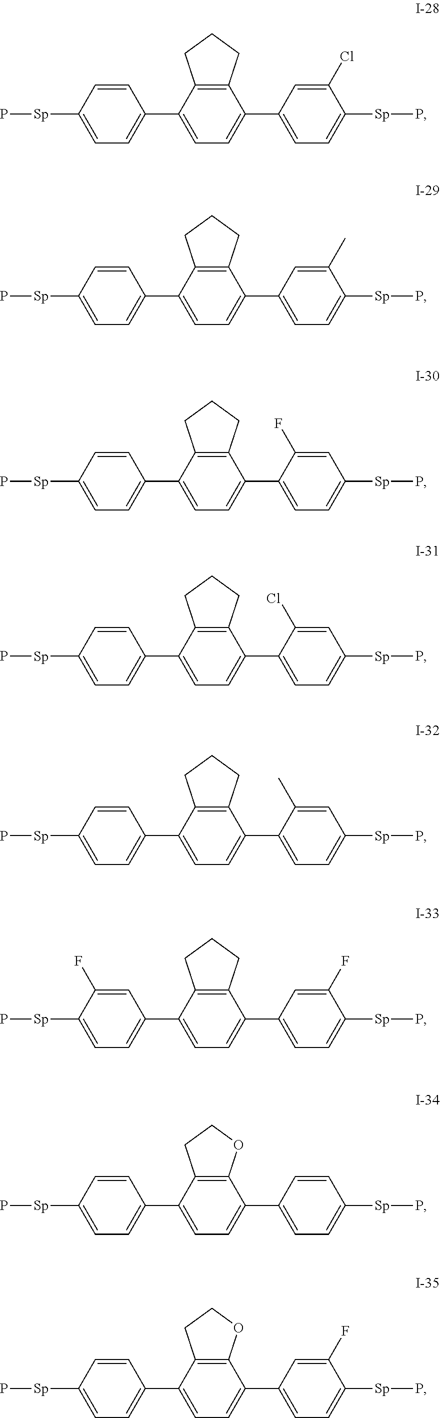

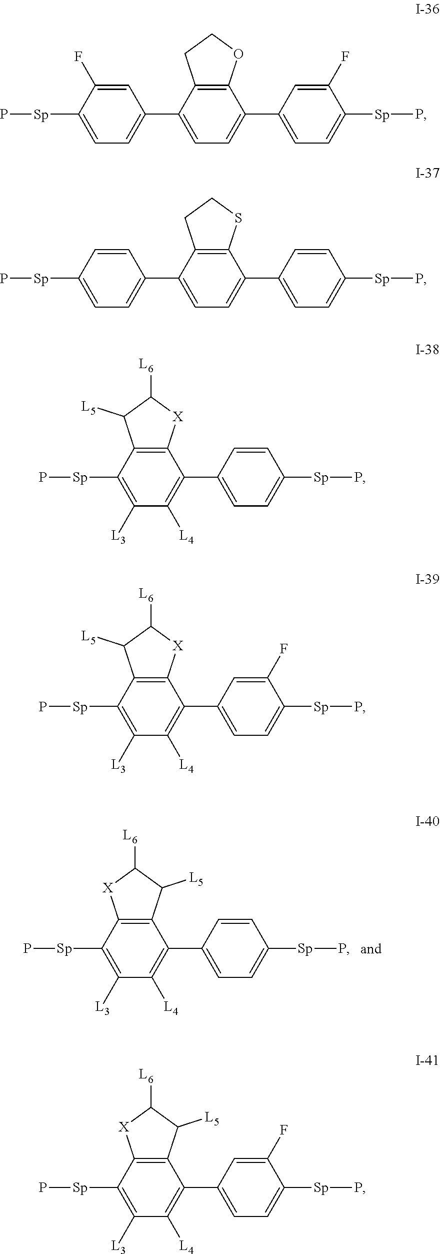

wherein
L₃, L₄, L₅, and L₆ are each independently selected from H, C1-C5 alkyl or alkoxy, C2-C5 alkenyl or alkenoxy, and halogen;
each occurrence of P independently represents an acrylate group, a methacrylate group, or a fluoroacrylate group;
Sp represents a single bond or a C1-C5 linear, branched or cyclic alkyl group, and the Sp groups are not both single bonds, wherein any one or more non-adjacent —CH₂— can be replaced by —O—, —S—, —CO—, —CH₂O—, —OCH₂—, —COO—, —OOC—, or an acrylate group in such a manner that O- or S-atoms are not directly connected with each other, one or more H atoms can be independently replaced by F, Cl, or G3, and at least one H atom is replaced by G3;
G3 represents a C1-C7 tertiary alcohol structure; and
X represents —CH₂—, —O—, or —S—.

Furthermore, the compound represented by formula I is at least one of compounds represented by formulas I-1-1 to I-41-5:

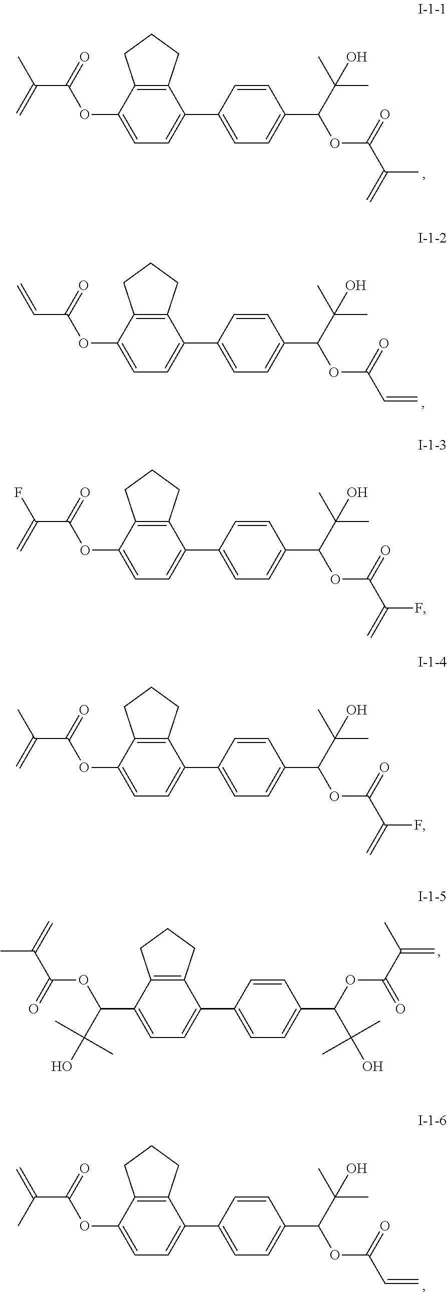

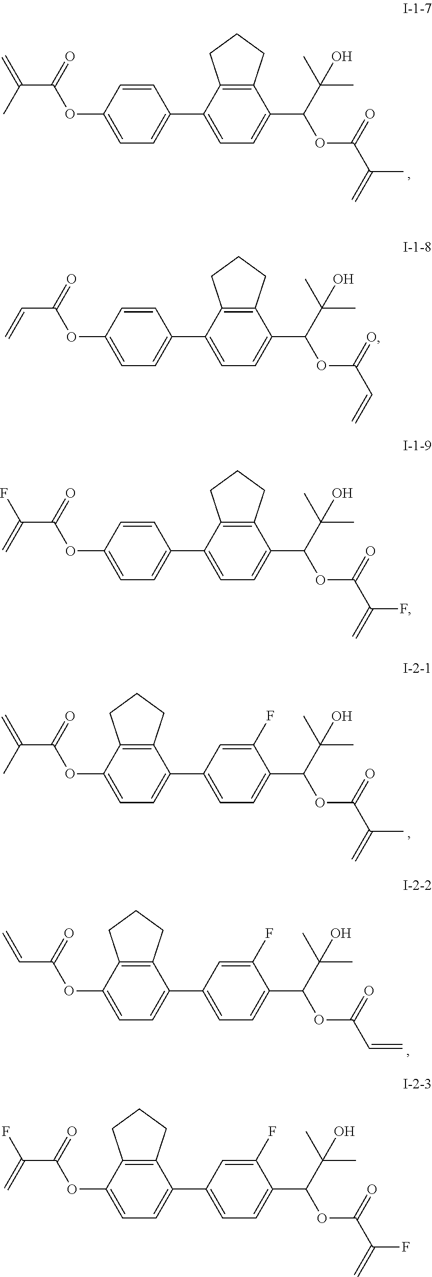

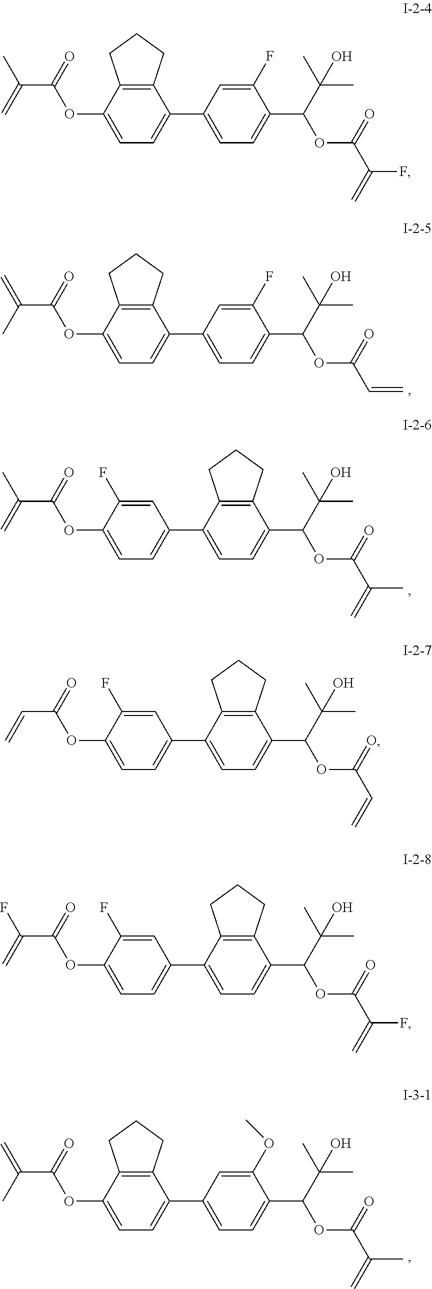

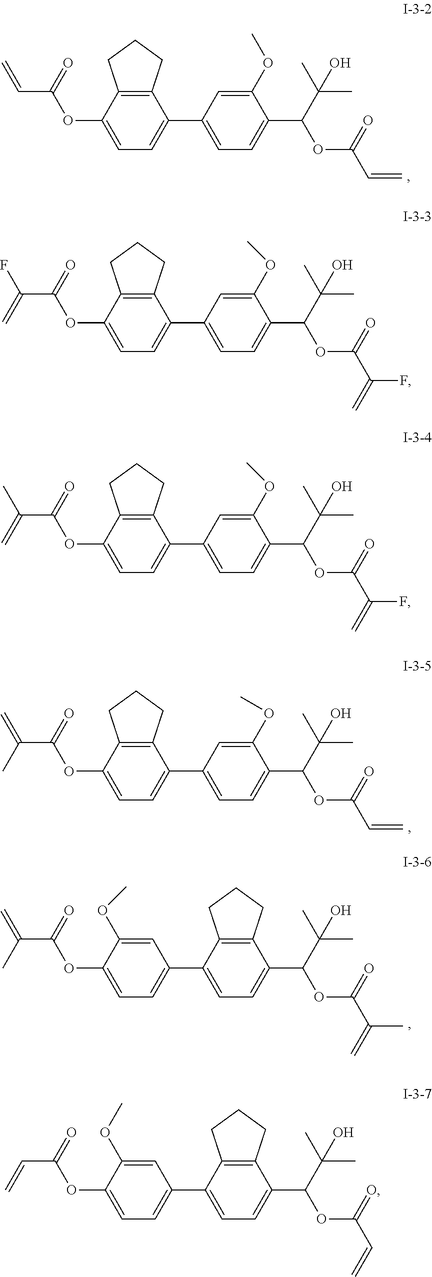

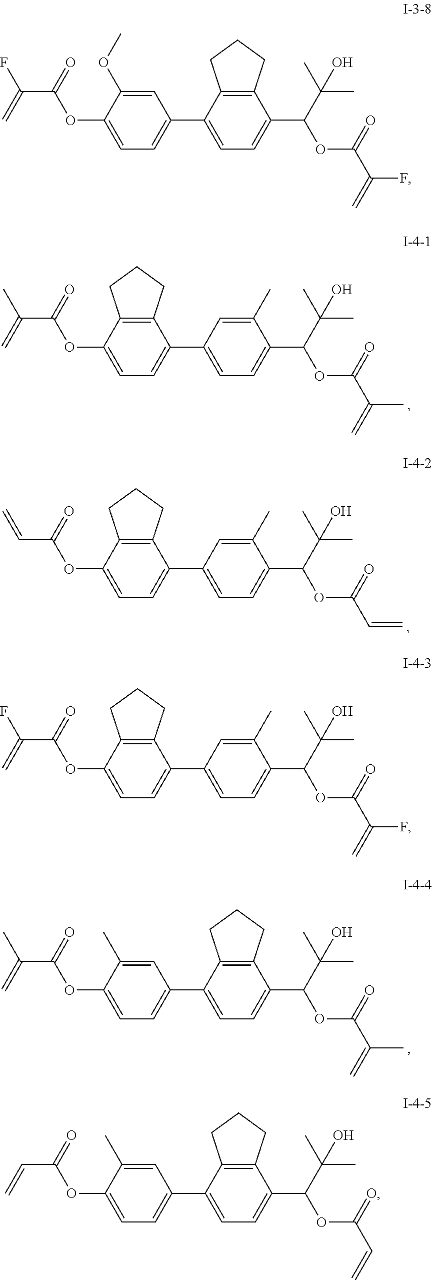

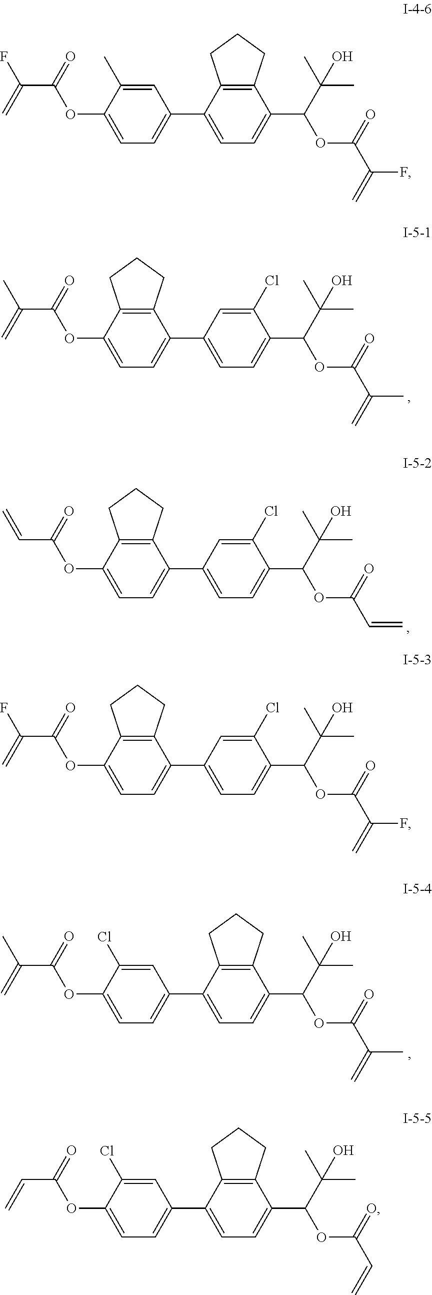

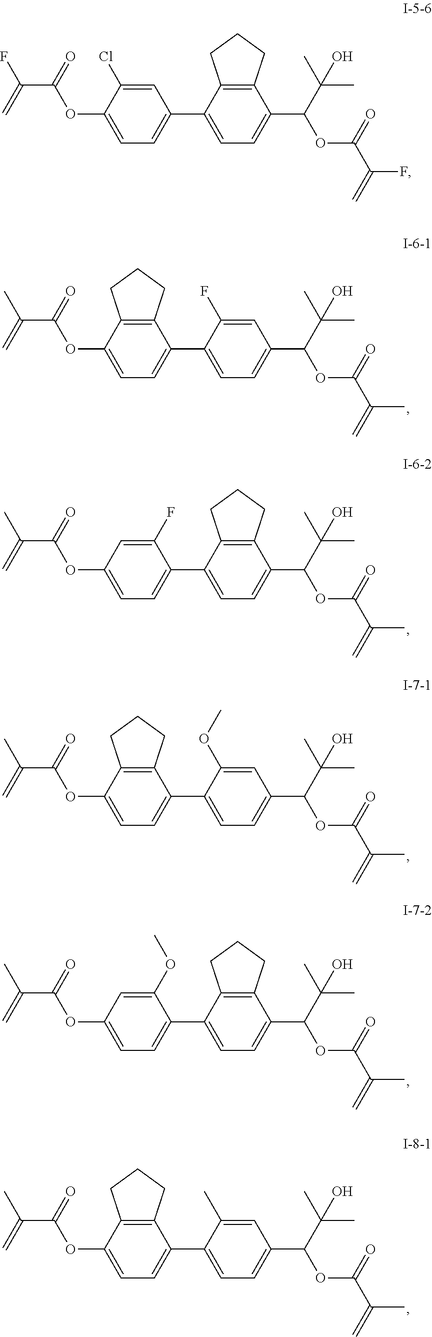

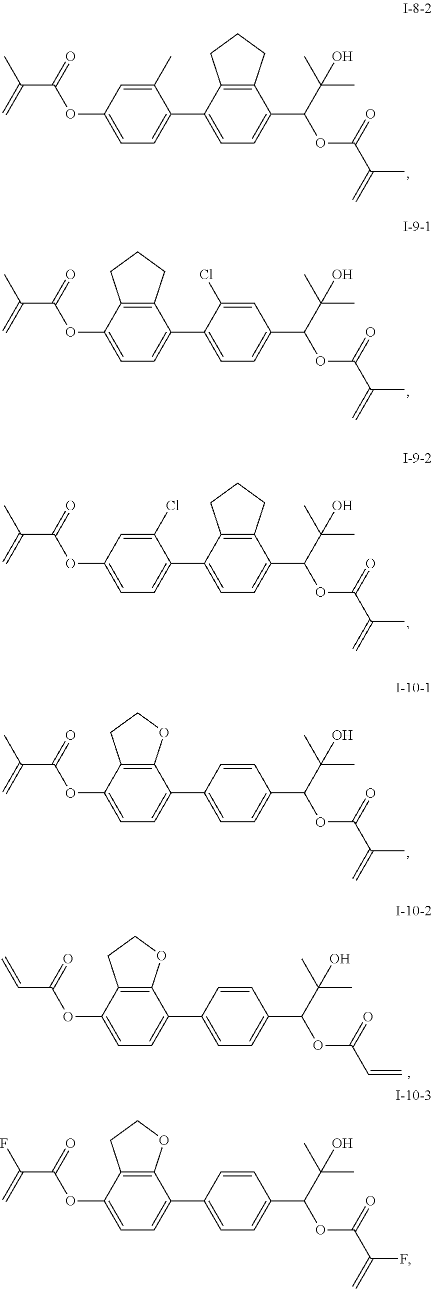

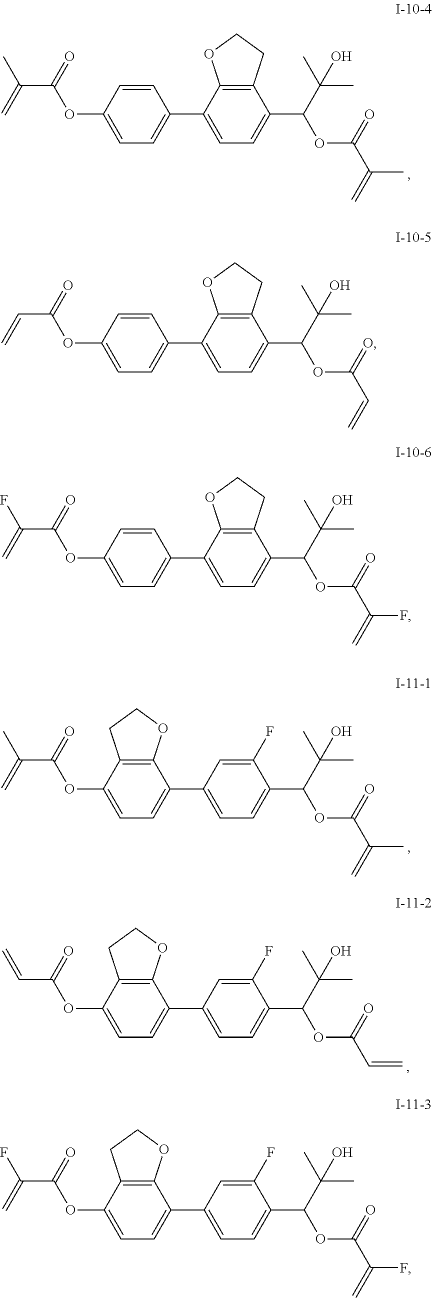

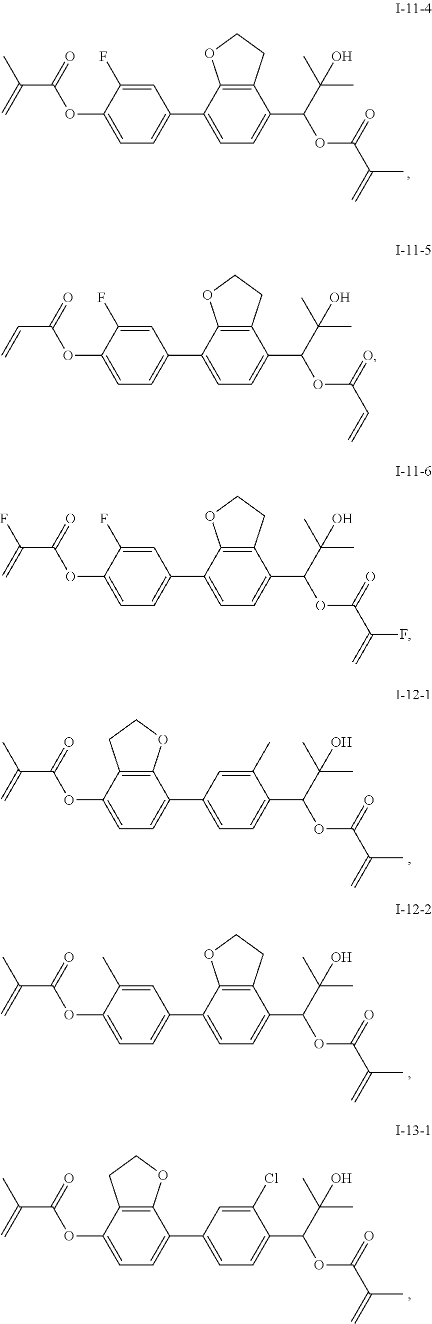

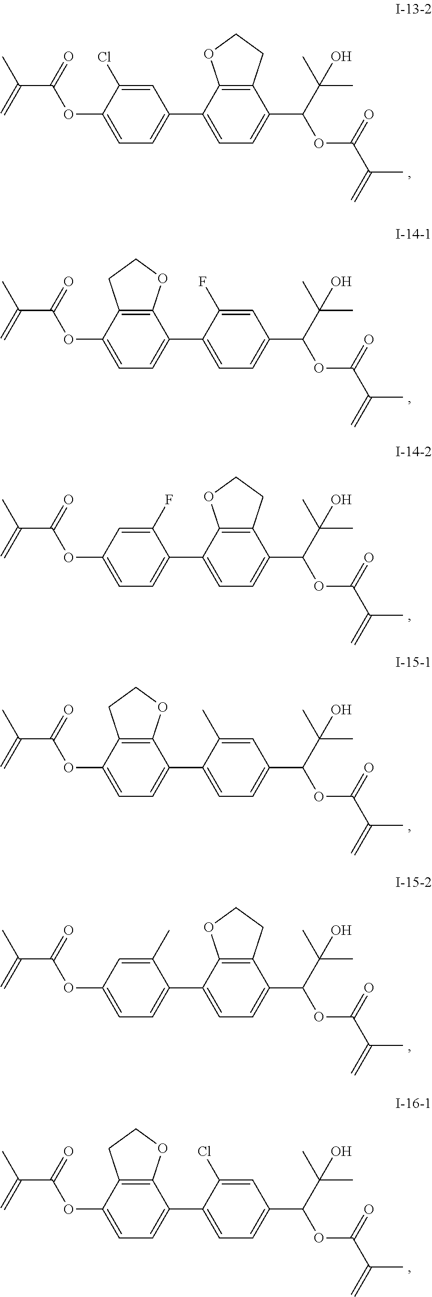

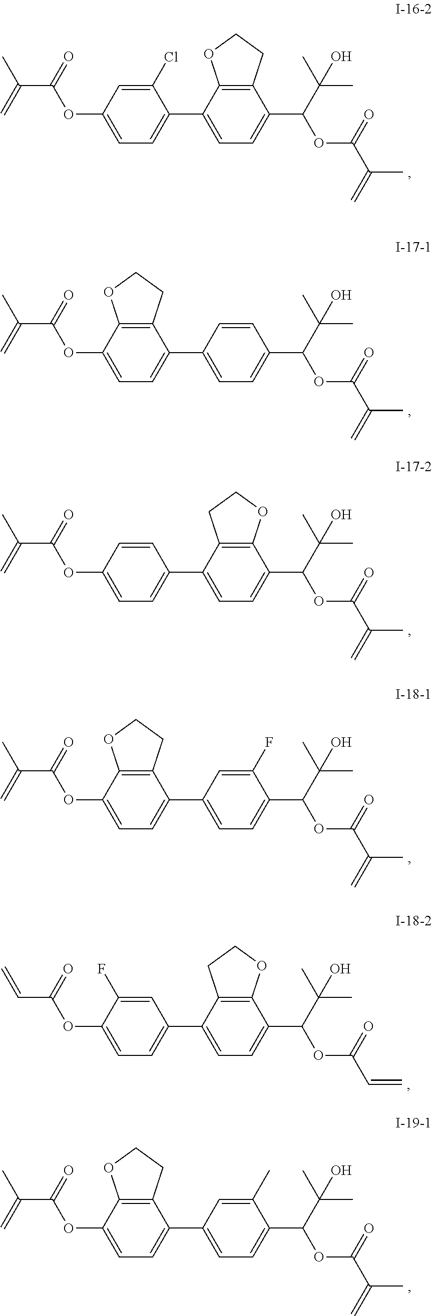

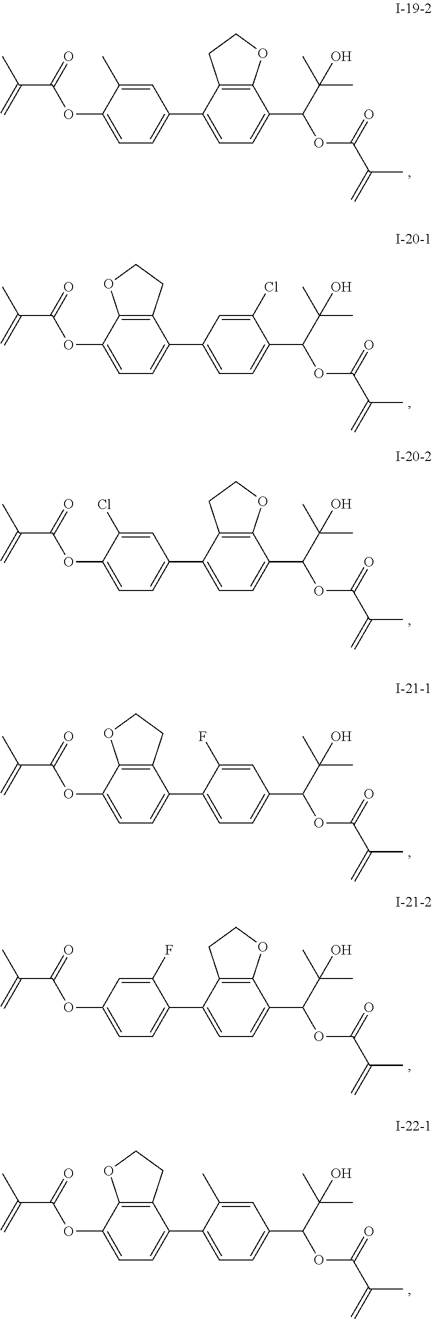

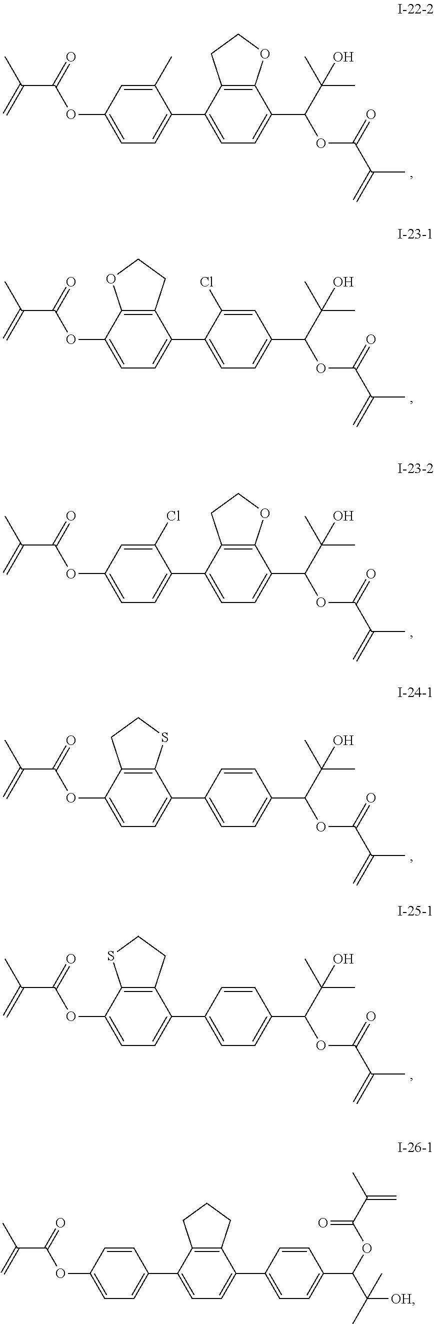

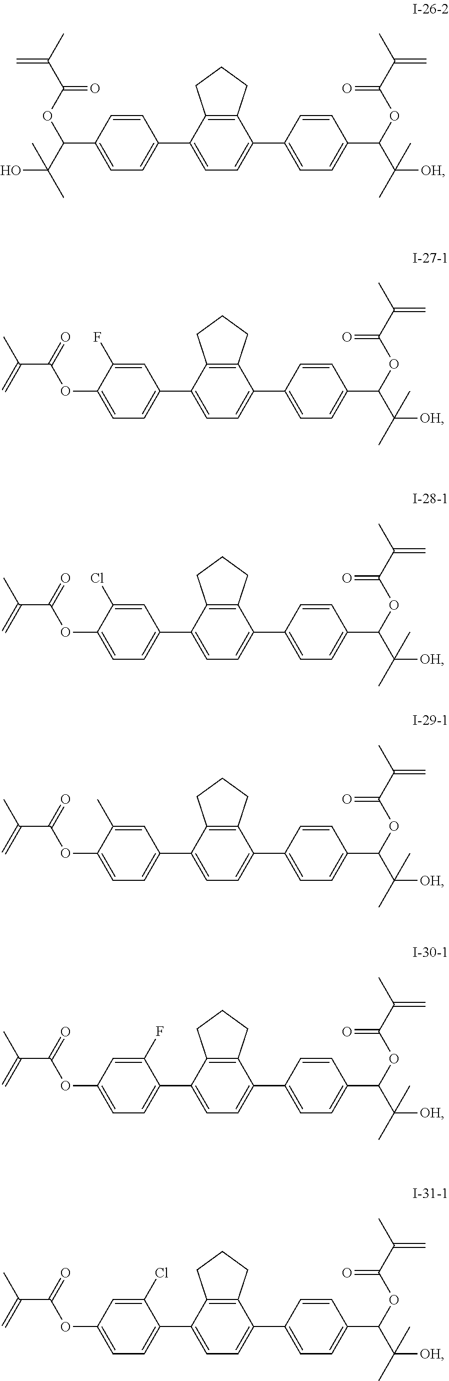 [SMILES: C=C(C)C(=O)OC(c1ccc(-c2ccc(-c3ccc(C(OC(=O)C(=C)C)C(C)(C)O)cc3)c3c2CCC3)cc1)C(C)(C)O ; C=C(C)C(=O)Oc1ccc(-c2ccc(-c3ccc(C(OC(=O)C(=C)C)C(C)(C)O)cc3)c3c2CCC3)cc1F ; C=C(C)C(=O)Oc1ccc(-c2ccc(-c3ccc(C(OC(=O)C(=C)C)C(C)(C)O)cc3)c3c2CCC3)cc1Cl ; C=C(C)C(=O)Oc1ccc(-c2ccc(-c3ccc(C(OC(=O)C(=C)C)C(C)(C)O)cc3)c3c2CCC3)cc1C ; C=C(C)C(=O)Oc1ccc(-c2ccc(-c3ccc(C(OC(=O)C(=C)C)C(C)(C)O)cc3)c3c2CCC3)c(F)c1 ; C=C(C)C(=O)Oc1ccc(-c2ccc(-c3ccc(C(OC(=O)C(=C)C)C(C)(C)O)cc3)c3c2CCC3)c(Cl)c1]

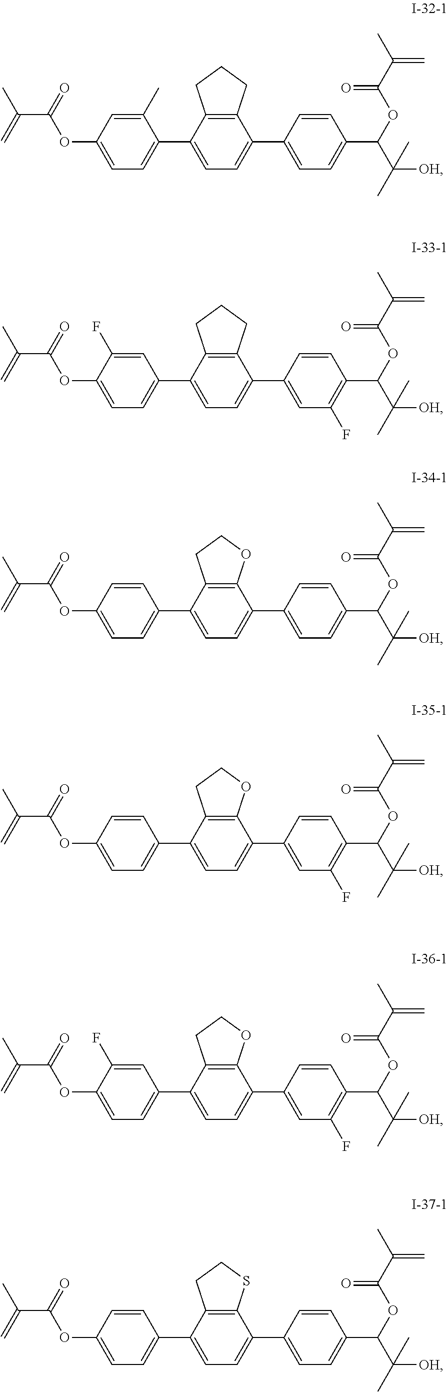 [SMILES: C=C(C)C(=O)Oc1ccc(-c2ccc(-c3ccc(C(OC(=O)C(=C)C)C(C)(C)O)cc3)c3c2CCC3)c(C)c1 ; C=C(C)C(=O)Oc1ccc(-c2ccc(-c3ccc(C(OC(=O)C(=C)C)C(C)(C)O)c(F)c3)c3c2CCC3)cc1F ; C=C(C)C(=O)Oc1ccc(-c2ccc(-c3ccc(C(OC(=O)C(=C)C)C(C)(C)O)cc3)c3c2CCO3)cc1 ; C=C(C)C(=O)Oc1ccc(-c2ccc(-c3ccc(C(OC(=O)C(=C)C)C(C)(C)O)c(F)c3)c3c2CCO3)cc1 ; C=C(C)C(=O)Oc1ccc(-c2ccc(-c3ccc(C(OC(=O)C(=C)C)C(C)(C)O)c(F)c3)c3c2CCO3)cc1F ; C=C(C)C(=O)Oc1ccc(-c2ccc(-c3ccc(C(OC(=O)C(=C)C)C(C)(C)O)cc3)c3c2CCS3)cc1]

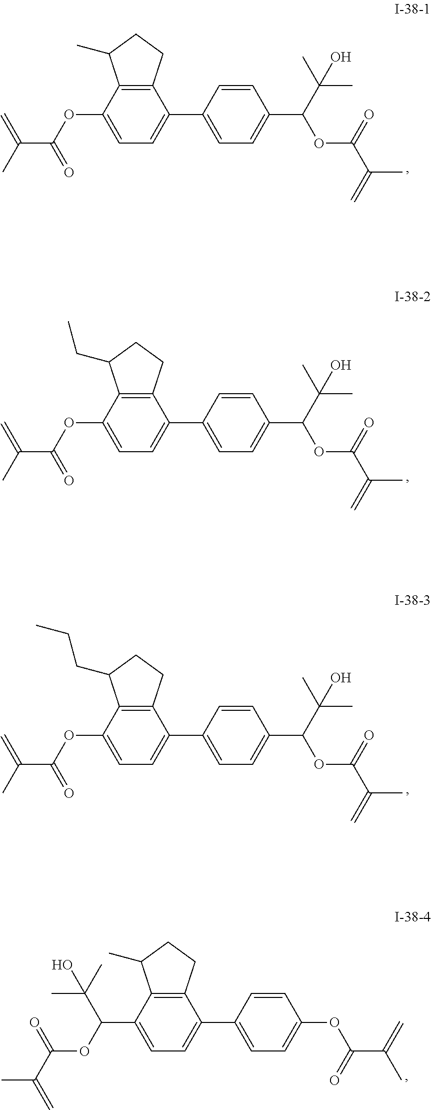

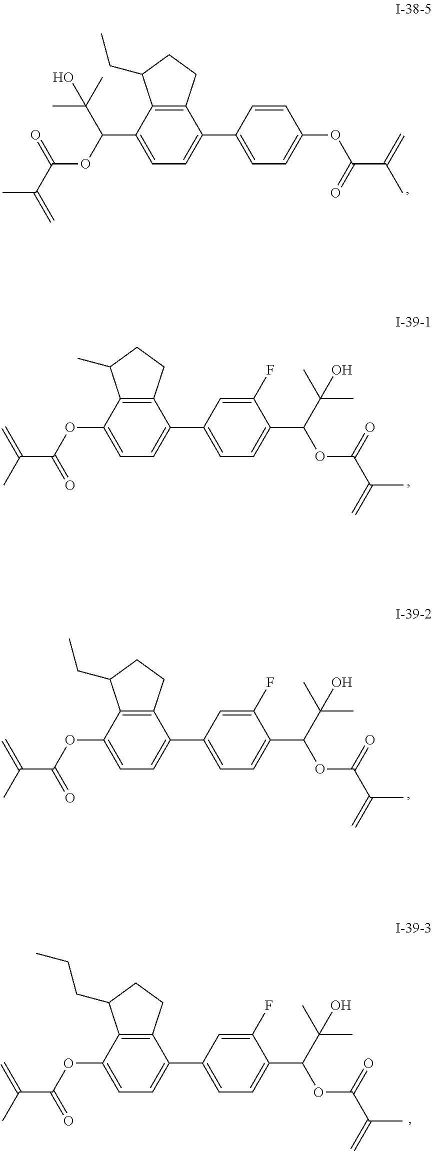

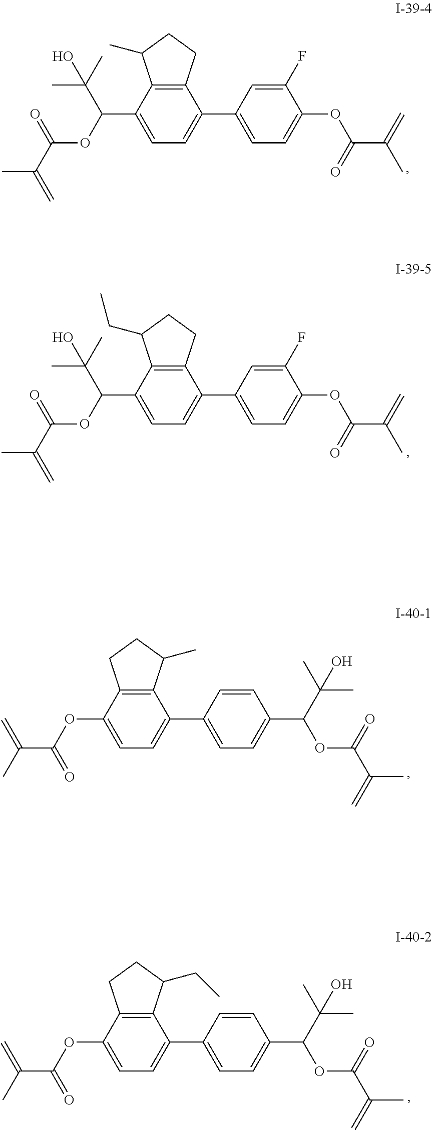

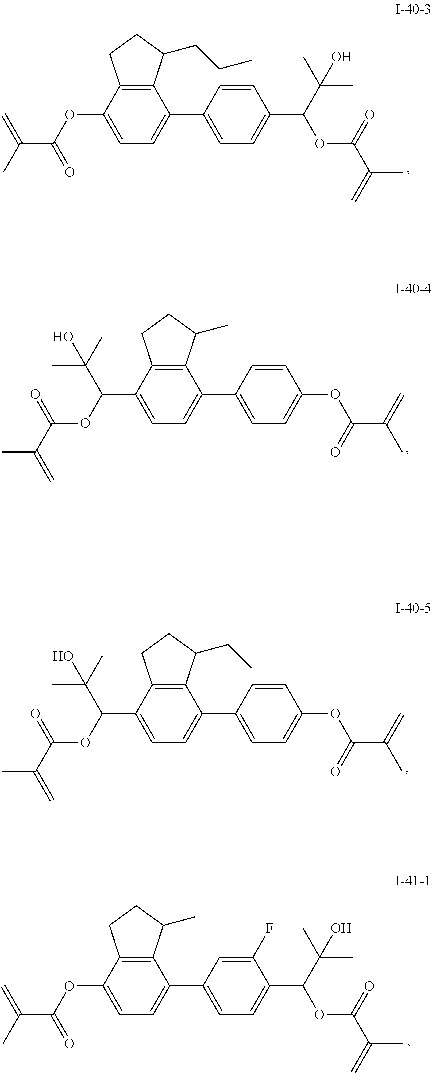

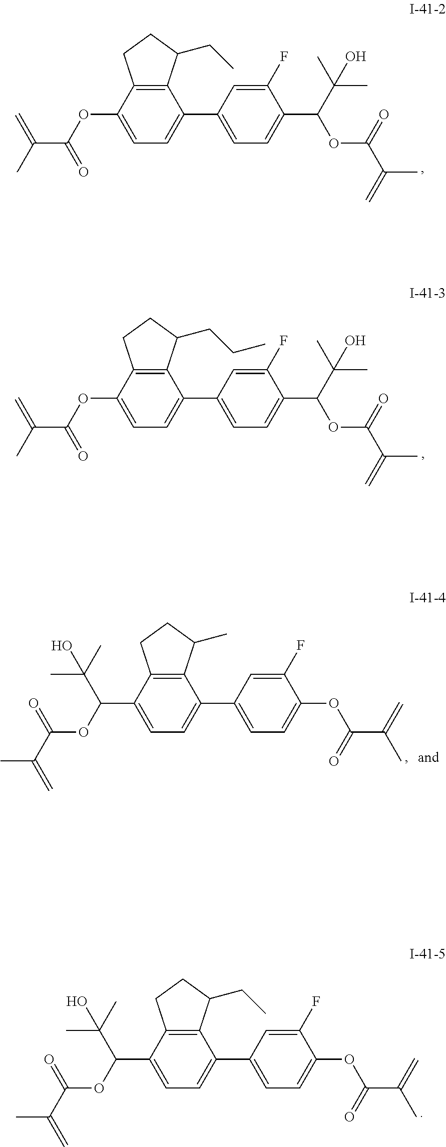

In a further aspect, the present invention provides a liquid crystal composition comprising one or more polymerizable compounds as defined in the first aspect as a first component, one or more compounds represented by formula II as a second component, and one or more compounds represented by formula III as a third component:

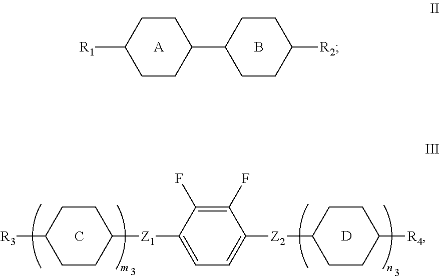

wherein
R₁, R₂, R₃, and R₄ each independently represent C1-C10 alkyl, C1-C10 alkoxy, or C2-C10 alkenyl, wherein one or more non-adjacent —CH₂— can be replaced by cyclopropyl, cyclopentyl, or cyclobutyl;
Z₁ and Z₂ each independently represent —CH₂—CH₂—, —O—, —CO—, —CO—O—, —O—CO—, —CH₂O—, —OCH₂—, —CH═CH—, —CF₂O—, or a single bond;

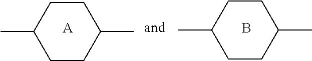

each independently represent 1,4-phenylene, 1,4-cyclohexylidene, or 1,4-cyclohexenylene;

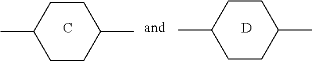

each independently represent 1,4-phenylene, 2,3-difluoro-1,4-phenylene, 2-fluoro-1,4-phenylene, 3-fluoro-1,4-phenylene, trans-1,4-cyclohexylidene, or 1,4-cyclohexenylene, wherein one or two-CH₂— can be replaced by —O—;
m₃ represents 1 or 2; and
n₃ represents 0, 1, or 2.

Furthermore, the one or more compounds represented by formula II is one or more compounds of formulas II-1 to II-15:

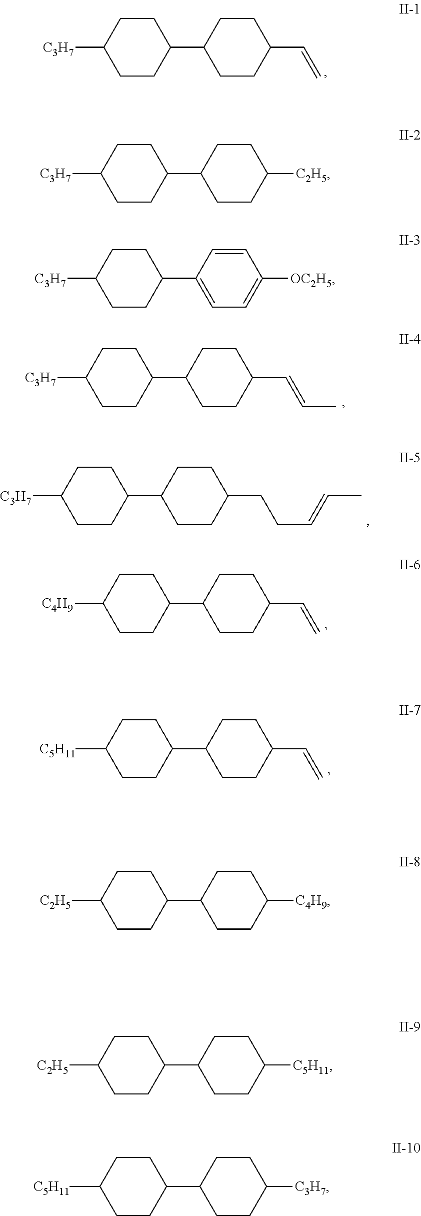

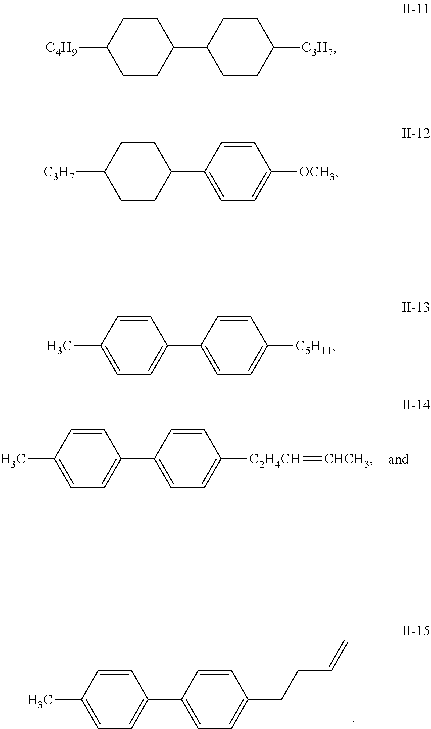

Furthermore, the one or more compounds represented by formula III is one or more compounds represented by formulas III-1 to III-12:

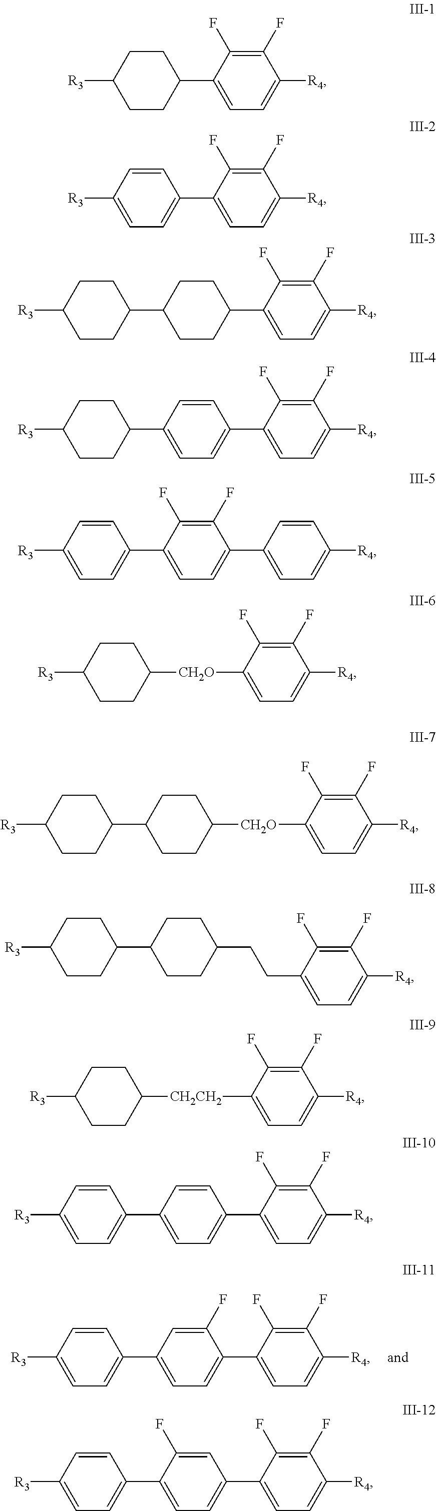

wherein
R₃ and R₄ each independently represent C1-C10 alkyl, C1-C10 alkoxy, or C2-C10 alkenyl, wherein one or more non-adjacent —CH₂— can be replaced by cyclopropyl, cyclopentyl, or cyclobutyl.

Furthermore, the liquid crystal composition is a negative liquid crystal composition, and the liquid crystal composition further comprises one or more compounds represented by formula IV:

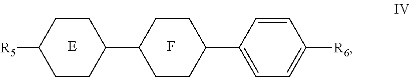

wherein
R₅ and R₆ each independently represent C1-C10 alkyl, fluorine-substituted C1-C10 alkyl, C1-C10 alkoxy, fluorine-substituted C1-C10 alkoxy, C2-C10alkenyl, fluorine-substituted C2-C10 alkenyl, C3-C8 alkenoxy, or fluorine-substituted C3-C8 alkenoxy;

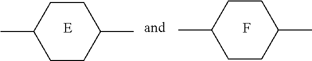

each independently represent 1,4-phenylene, 1,4-cyclohexylene, or 1,4-cyclohexenylene.

Furthermore, the liquid crystal composition further comprises one or more compounds represented by formula V:

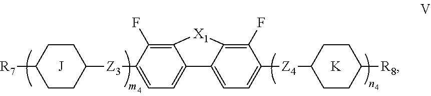

wherein
R₇ and R₈ each independently represent an H atom, halogen, C1-C10 alkyl, C1-C10 fluoroalkyl, C1-C10 alkoxy, or C1-C10 fluoroalkoxy, and any one or more CH₂ in the groups represented by R₇ and R₈ can be replaced by cyclopentyl, cyclobutyl, or cyclopropyl;
X₁ represents —O—, —S—, —CO—, or —CH₂O—;
Z₃ and Z₄ each independently represent —O—, —CO—, —CO—O—, —O—CO—, —CH₂O—, —OCH₂—, —CH═CH—, —CF₂O—, or a single bond;

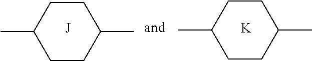

each independently represent cyclopropyl, cyclobutyl, cyclopentyl, 1,4-phenylene, 2,3-difluoro-1,4-phenylene, 2-fluoro-1,4-phenylene, 3-fluoro-1,4-phenylene, trans-1,4-cyclohexylidene, or 1,4-cyclohexenylene;
m₄ represents 0, 1, or 2; and
n₄ represents 0, 1, or 2.

Furthermore, the liquid crystal composition is a negative liquid crystal composition, and the liquid crystal composition further comprises one or more compounds represented by formula VI:

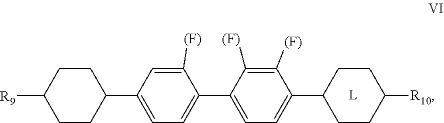

wherein
R₉ and R₁₀ each independently represent C1-C10 alkyl, fluorine-substituted C1-C10 alkyl, C1-C10 alkoxy, fluorine-substituted C1-C10 alkoxy, C2-C10alkenyl, fluorine-substituted C2-C10 alkenyl, C3-C8 alkenoxy, or fluorine-substituted C3-C8 alkenoxy;

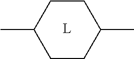

represents 1,4-phenylene, 1,4-cyclohexylidene, or 1,4-cyclohexenylene; and
each occurrence of (F) independently represents H or F.

Furthermore, in the liquid crystal composition, the total mass percentage content of the compounds represented by formula I is 0.01-1%, the total mass percentage content of the compounds represented by formula II is 15-60%, and the total mass percentage content of the compounds represented by formula III is 20-80%.

In still further aspect, the present invention provides a liquid crystal display device comprising the liquid crystal composition as described above.

Furthermore, the liquid crystal display device is a PSVA or SAVA display.

### BENEFICIAL EFFECTS OF THE INVENTION

The polymerizable compound of the present invention contains a benzene-fused ring system in the main ring and necessarily a tertiary alcohol branch structure. The polymerizable compound has the advantages of good diffusivity and low residue after a UV process. In addition, after the liquid crystal composition comprising the polymerizable compound is applied to a liquid crystal display device, it can be ensured that the IS performance of the display is excellent under extreme conditions (high temperature, low temperature, high- and low-temperature cycling, and high temperature and high humidity), and the risk of problems such as image sticking on the final display is reduced, so that a liquid crystal display device having more excellent quality can be provided.

### BRIEF DESCRIPTION OF THE DRAWINGS

Specific embodiments of the present invention will be described in further detail with reference to the accompanying drawings.

FIG. 1 shows a mass spectrum of a compound represented by formula I-1-1.

FIG. 2 shows a mass spectrum of a compound represented by formula I-38-2.

### DETAILED DESCRIPTION OF EMBODIMENTS

In order to explain the present invention more clearly, the present invention will be further explained below in conjunction with preferred examples and the accompanying drawings. In the drawings, like parts are denoted by like reference signs. A person skilled in the art should understand that the following detailed description is illustrative rather than restrictive, and should not limit the scope of protection of the present invention.

According to a specific embodiment of the present invention, there is provided a polymerizable compound. The polymerizable compound is a compound represented by the following formula I:

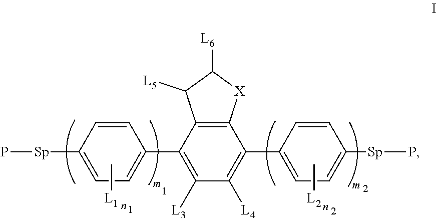

wherein
L₁ and L₂ are each independently selected from H, C1-C5 alkyl or alkoxy, C2-C5 alkenyl or alkenoxy, fluorine-substituted C1-C5 alkyl or alkoxy, fluorine-substituted C2-C5 alkenyl or alkenoxy, and halogen, wherein any one or more non-adjacent —CH₂— can be each independently replaced by —O—, —S—, —CO—, —CH₂O—, —OCH₂—, —COO—, —OOC—, or —Sp—;
L₃, L₄, L₅, and L₆ are each independently selected from H, C1-C5 alkyl or alkoxy, C2-C5 alkenyl or alkenoxy, fluorine-substituted C1-C5 alkyl or alkoxy, fluorine-substituted C2-C5 alkenyl or alkenoxy, and halogen;
n₁ and n₂ each independently represent 0, 1, 2, 3, or 4;
m₁ and m₂ each independently represent 0 or 1, and m₁ and m₂ are not both 0;
each occurrence of P independently represents an acrylate group, a methacrylate group, or a fluoroacrylate group;
Sp represents a single bond or a C1-C5 linear, branched or cyclic alkyl group, and the Sp groups are not both single bonds, wherein any one or more non-adjacent —CH₂— can be replaced by —O—, —S—, —CO—, —CH₂O—, —OCH₂—, —COO—, —OOC—, or an acrylate group in such a manner that O- or S-atoms are not directly connected with each other, one or more H atoms can be independently replaced by F, Cl, or G3, and at least one H atom is replaced by G3;
G3 represents a C1-C7 tertiary alcohol structure; and
X represents —CH₂—, —O—, or —S—.

In this embodiment, the acrylate group is

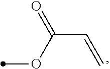

the methacrylate group is

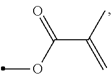

and the fluoroacrylate group is

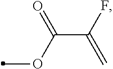

wherein · represents the site of connection.

In this embodiment, exemplary halogens include, but are not limited to, those selected from F, Cl, Br, etc.

In some preferred examples, the compound represented by formula I is a compound represented by formula I-1, formula I-10, or formula I-38. Under this condition, the polymerizable compound has better diffusivity and lower residue after a UV process. In addition, when the liquid crystal composition comprising the polymerizable compound is applied to a liquid crystal display device, it can be ensured that the IS performance of the display is more excellent after extreme conditions (high temperature, low temperature, high- and low-temperature cycling, and high temperature and high humidity).

According to a further specific embodiment of the present invention, there is provided a liquid crystal composition. The liquid crystal composition comprises one or more polymerizable compounds as described above as a first component, one or more compounds as represented by formula II as a second component, and one or more compounds as represented by formula III as a third component:

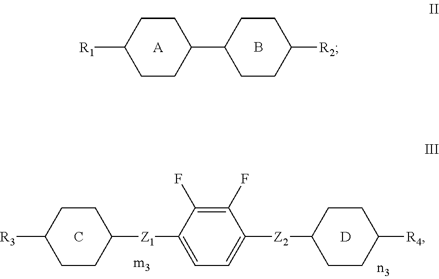

wherein
R₁, R₂, R₃, and R₄ each independently represent C1-C10 alkyl, C1-C10 alkoxy, or C2-C10 alkenyl, wherein one or more non-adjacent —CH₂— can be replaced by cyclopropyl, cyclopentyl, or cyclobutyl;
Z₁ and Z₂ each independently represent —CH₂—CH₂—, —O—, —CO—, —CO—O—, —O—CO—, —CH2O—, —OCH₂—, —CH═CH—, —CF₂O—, or a single bond;

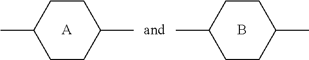

each independently represent 1,4-phenylene, 1,4-cyclohexylidene, or 1,4-cyclohexenylene;

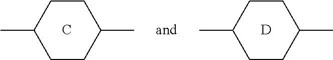

each independently represent 1,4-phenylene, 2,3-difluoro-1,4-phenylene, 2-fluoro-1,4-phenylene, 3-fluoro-1,4-phenylene, trans-1,4-cyclohexylidene, or 1,4-cyclohexenylene, wherein one or two-CH₂— can be replaced by —O—;
m₃ represents 1 or 2; and
n₃ represents 0, 1, or 2.

The liquid crystal composition is also namely a polymerized liquid crystal composition. In a display in which the liquid crystal composition is used, by adding the compound represented by formula I to a liquid crystal medium, introducing the mixture into a liquid crystal cell, and then performing UV-induced photopolymerization or crosslinking under a voltage applied between electrodes, a pretilt of liquid crystal molecules can be formed. This is beneficial to simplifying the LCD production process, improving the response speed, and reducing the threshold voltage.

In some examples, in the liquid crystal composition, the total mass percentage content of the compounds represented by formula I is 0.01-1%, preferably 0.03-0.5%, more preferably 0.1-0.5% or 0.2-0.4%.

In some examples, in the liquid crystal composition, the total mass percentage content of the compounds represented by formula II is 15-60%, preferably 20-40%, more preferably 25-35%.

In some examples, in the liquid crystal composition, the total mass percentage content of the compounds represented by formula III is 20-80%, preferably 30-70%, more preferably 45-65%.

In some examples, the liquid crystal composition is a negative liquid crystal composition, and the liquid crystal composition further comprises one or more compounds represented by formula IV:

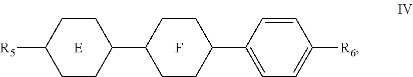

wherein
R₅ and R₆ each independently represent C1-C10 alkyl, fluorine-substituted C1-C10 alkyl, C1-C10 alkoxy, fluorine-substituted C1-C10 alkoxy, C2-C10alkenyl, fluorine-substituted C2-C10 alkenyl, C3-C8 alkenoxy, or fluorine-substituted C3-C8 alkenoxy;

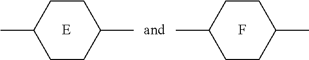

each independently represent 1,4-phenylene, 1,4-cyclohexylene, or 1,4-cyclohexenylene.

In some preferred examples, the compound represented by formula IV is selected from compounds represented by the following formulas IV-1 to IV-4:

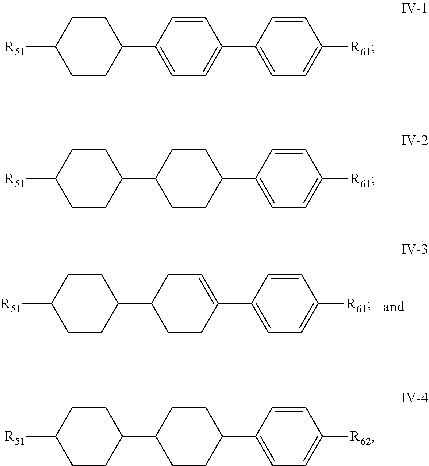

wherein R₅₁ and R₆₁ each independently represent C2-C6 alkyl or C2-C6 alkenyl, and R₆₂ represents C1-C5 alkoxy.

In some preferred examples, R₅₁ and R₆₁ are vinyl, 2-propenyl, or 3-pentenyl.

In some examples, in the liquid crystal composition, the total mass percentage content of the compounds represented by formula IV is 2-15%, preferably 4-15%.

In some examples, the liquid crystal composition further comprises one or more compounds represented by formula V:

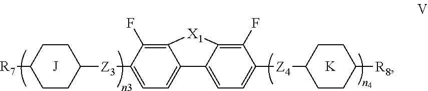

wherein
R₇ and R₈ each independently represent an H atom, halogen, C1-C10 alkyl, C1-C10 fluoroalkyl, C1-C10 alkoxy, or C1-C10 fluoroalkoxy, and any one or more CH₂ in the groups represented by R₇ and R₈ can be replaced by cyclopentyl, cyclobutyl, or cyclopropyl;
X₁ represents —O—, —S—, —CO—, or —CH₂O—;
Z₃ and Z₄ each independently represent —O—, —CO—, —CO—O—, —O—CO—, —CH₂O—, —OCH₂—, —CH═CH—, —CF₂O—, or a single bond;

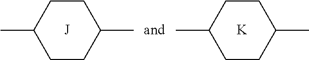

each independently represent cyclopropyl, cyclobutyl, cyclopentyl, 1,4-phenylene, 2,3-difluoro-1,4-phenylene, 2-fluoro-1,4-phenylene, 3-fluoro-1,4-phenylene, trans-1,4-cyclohexylidene, or 1,4-cyclohexenylene;
m₄ represents 0, 1, or 2; and
n₄ represents 0, 1, or 2.

In some preferred examples, the compound represented by formula Vis selected from compounds represented by the following formulas V-1 to V-6:

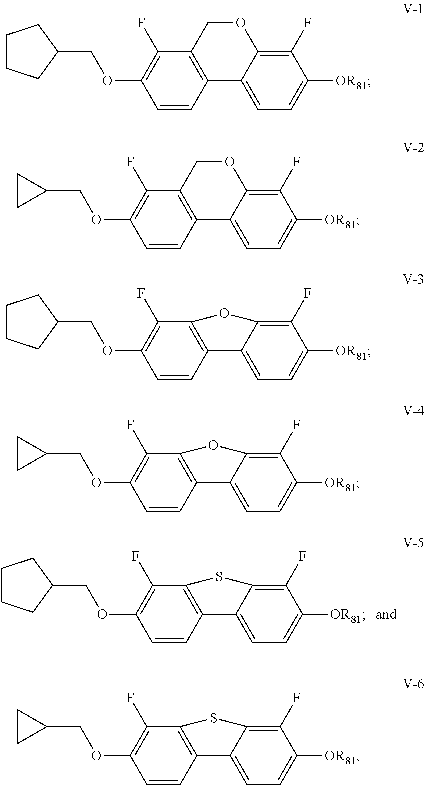

wherein each R₈₁ independently represents C2-C6 alkyl.

In some examples, in the liquid crystal composition, the total mass percentage content of the compounds represented by formula Vis 2-5%.

In some examples, the liquid crystal composition is a negative liquid crystal composition, and the liquid crystal composition further comprises one or more compounds represented by formula VI:

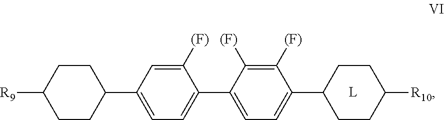

wherein
R₉ and R₁₀ each independently represent C1-C10 alkyl, fluorine-substituted C1-C10 alkyl, C1-C10 alkoxy, fluorine-substituted C1-C10 alkoxy, C2-C10alkenyl, fluorine-substituted C2-C10 alkenyl, C3-C8 alkenoxy, or fluorine-substituted C3-C8 alkenoxy;

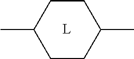

represents 1,4-phenylene, 1,4-cyclohexylidene, or 1,4-cyclohexenylene; and
each (F) independently represents H or F.

In some examples, the compound represented by formula VI is selected from compounds represented by the following formulas VI-1 to VI-3:

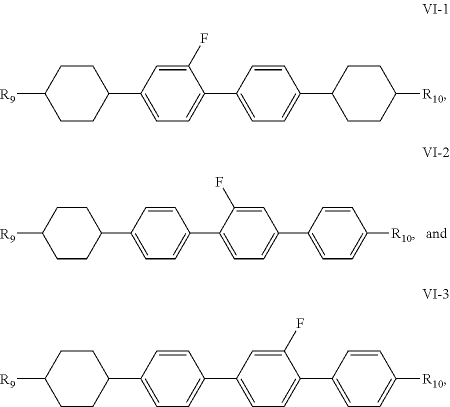

wherein R₉ and R₁₀ each independently represent C2-C6 alkyl or C2-C6 alkenyl.

In some examples, in the liquid crystal composition, the total mass percentage content of the compounds represented by formula VI is 1-3%.

Various functional dopants can also be added to the liquid crystal compound provided in this embodiment, and the mass percentage content of exemplary dopants is preferably between 0.01% and 1%. These dopants are mainly antioxidants, ultraviolet absorbers, and chiral agents.

Exemplary antioxidants and ultraviolet absorbers are preferably selected from:

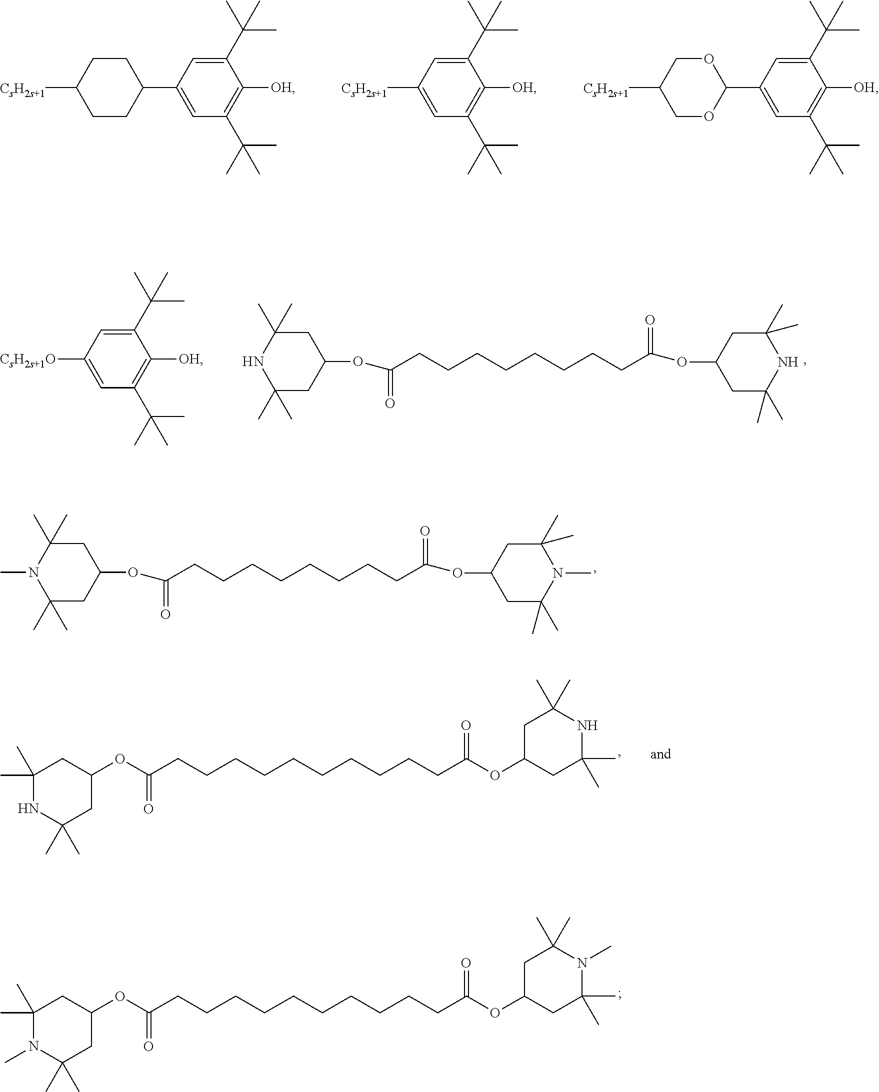

S represents an integer of 1-10.

According to another specific embodiment of the present invention, there is provided a liquid crystal display device comprising the liquid crystal composition as described above.

In some examples, the liquid crystal display device is a PSVA or SAVA display.

The technical solution of the present invention will be described below with reference to some specific examples:

In the present description, unless otherwise specified, all the percentages refer to mass percentages, the temperatures are in degrees Celsius (C), and the specific meanings of the other symbols and the test conditions are as follows:

Cp represents the clear point of a liquid crystal (° C.), which is measured by a DSC quantitative method.

Δn represents optical anisotropy, no is the refractive index of ordinary light, and ne is the refractive index of extraordinary light. The test conditions are 25° C.±2° C., 589 nm, and testing by Abbe refractometer.

As represents dielectric anisotropy, Δε=ε_{//}−ε_{⊥}, wherein ε_{//} is the dielectric constant parallel to the molecular axis, and &1 is the dielectric constant perpendicular to the molecular axis. The test conditions are 25° C.±0.5° C., 20 micron vertical cells, and INSTEC: ALCT-IR1 test.

K₁₁ is splay elastic constant, and K₃₃ is bending elastic constant. The test conditions are: 25° C., INSTEC: ALCT-IR1, and 20 micron vertical cells.

γ1 represents rotational viscosity (mPa's), and the test conditions are 25° C.±0.5° C., 20 micron vertical cells, and INSTEC: ALCT-IR1 test.

UV2 time represents the time (min) for irradiation with ultraviolet light in a PSVA process.

RM residual represents the content (ppm) of the residue. At the same temperature and wavelength, the RM content is detected by a gradient method using the instrument: Agilent 1200.

IS grade represents image sticking level. After the above PSVA test cells having a cell thickness of 3.5 um are irradiated by UV1 and UV2 to form a pretilt angle of 88.5°±0.2°, the test cells are subjected to a 60 Hz short wave, a 19 V AC voltage, and a 2 V DC voltage, while being placed under various extreme conditions with backlight. After separately 500 hours of treatment, 1 h release is carried out. On a medium-to-low gray scale, direct observation or observation with an ND filter is carried out. During direct observation, none means optimal. During observation with the ND filter, the greater the ND value, the better the IS grade. For example, ND10 is superior to ND9. In the present solution, it is considered that both ND10 and no IS are feasible.

Measurement of diffusivity of RM (the distribution behavior of an additive): A test cell (8 cm×4 cm) is filled with a test mixture. After the filling with the mixture is complete, the test cell is dissected to separately obtain a lower part of the test cell (adjacent to a filling port, 4 cm×4 cm) and an upper part of the test cell (opposite to the filling port, 4 cm×4 cm). At the same temperature and wavelength, the RM contents in the lower part and the upper part are separately detected by a gradient method, with the instrument: Agilent 1200. The quality of diffusivity is determined by the concentration difference. The concentration difference A between the lower part and the upper part=the RM content in the lower part—the RM content in the upper part. The smaller the A, the better the diffusivity thereof. Diffusion test cells are divided into two types. One is a test cell in which neither of the upper and lower substrates has PI (SAVA mode), and the other type is a test cell in which both the upper and lower substrates have NISSAN PI (PSVA mode).

The preparation method for the liquid crystal composition involves: weighing various liquid crystal monomers at a certain ratio and putting the liquid crystal monomers into a stainless steel beaker, placing the stainless steel beaker containing these liquid crystal monomers on a magnetic stirring instrument for heating and melting, adding a magnetic rotor to the stainless steel beaker when most of the liquid crystal monomers in the stainless steel beaker have melted, uniformly stirring the mixture, and cooling the mixture to room temperature to obtain the liquid crystal composition.

The structures of the liquid crystal monomers in the examples of the present invention are represented by codes, and a code representation method for liquid crystal ring structures, terminal groups and linker groups is shown in Tables 1 and 2 below.

TABLE 1
Corresponding codes of ring structures

| Ring structure | Corresponding code |
|---|---|
| 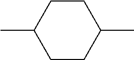 | C |
| 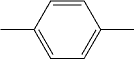 | P |
| 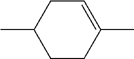 | L |
| 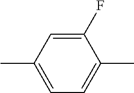 | G |
| 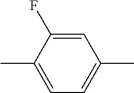 | Gi |
| 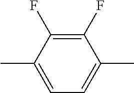 | Y |
| 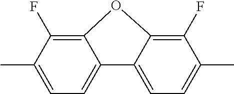 | Sb |
| 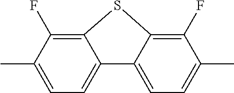 | Sc |

TABLE 2
Corresponding codes of terminal groups and linker groups

| Terminal groups and linker | |
|---|---|
| groups | Corresponding code |
| CₙH₂ₙ₊₁— | n- |
| CₙH₂ₙ₊₁O— | nO— |
| —CH₂O— | —O— |
| —F | —F |
| —CH₂CH₂— | —E— |
| —CH═CH— | —V— |
| —CH═CH—CₙH₂ₙ₊₁ | Vn- |
| —C≡C— | —W— |
| 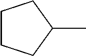 | Cp- |
| 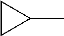 | Cpr- |
| 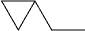 | Cpr1- |
| 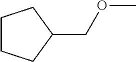 | CpO |
| 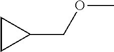 | CprO |

For example:

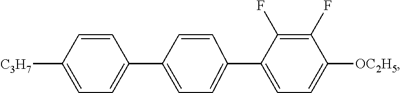

the code of which is PPY-3-O2;

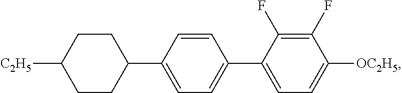 [SMILES: CCOc1ccc(-c2ccc(C3CCC(CC)CC3)cc2)c(F)c1F]

the code of which is CPY-2-O2;

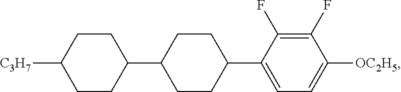

the code of which is CCY-3-O2;

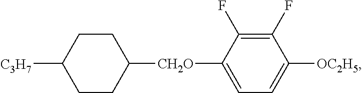

the code of which is COY-3-O2;

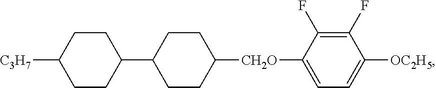

the code of which is CCOY-3-O2;

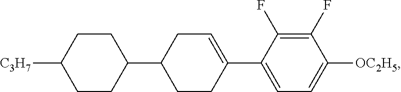

the code of which is CLY-3-O2;

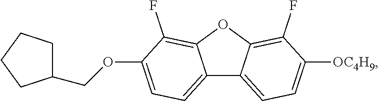

the code of which is Sb-CpO-O4;

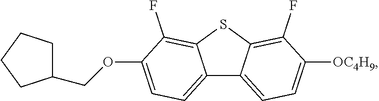

with the code being Sc-CpO-O4.

### Example 1

The structural formula of the polymerizable compound was as represented by the following formula I-1-1:

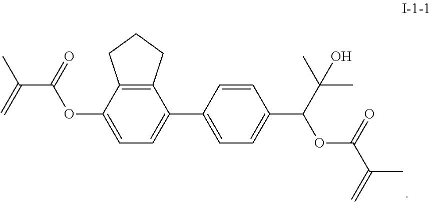 [SMILES: C=C(C)C(=O)Oc1ccc(-c2ccc(C(OC(=O)C(=C)C)C(C)(C)O)cc2)c2c1CCC2]

The preparation route thereof was as follows:

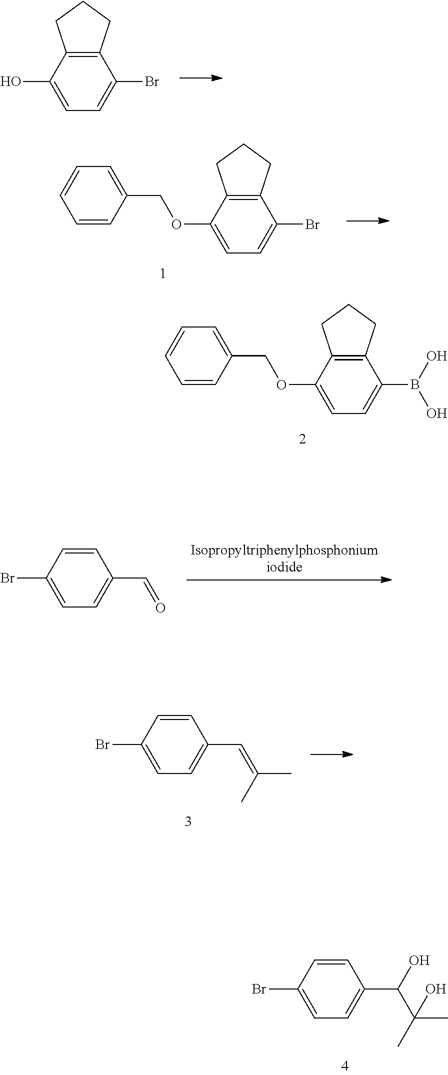 [SMILES: Oc1ccc(Br)c2c1CCC2 ; Brc1ccc(OCc2ccccc2)c2c1CCC2 ; OB(O)c1ccc(OCc2ccccc2)c2c1CCC2 ; O=Cc1ccc(Br)cc1 ; CC(C)=Cc1ccc(Br)cc1 ; CC(C)(O)C(O)c1ccc(Br)cc1]

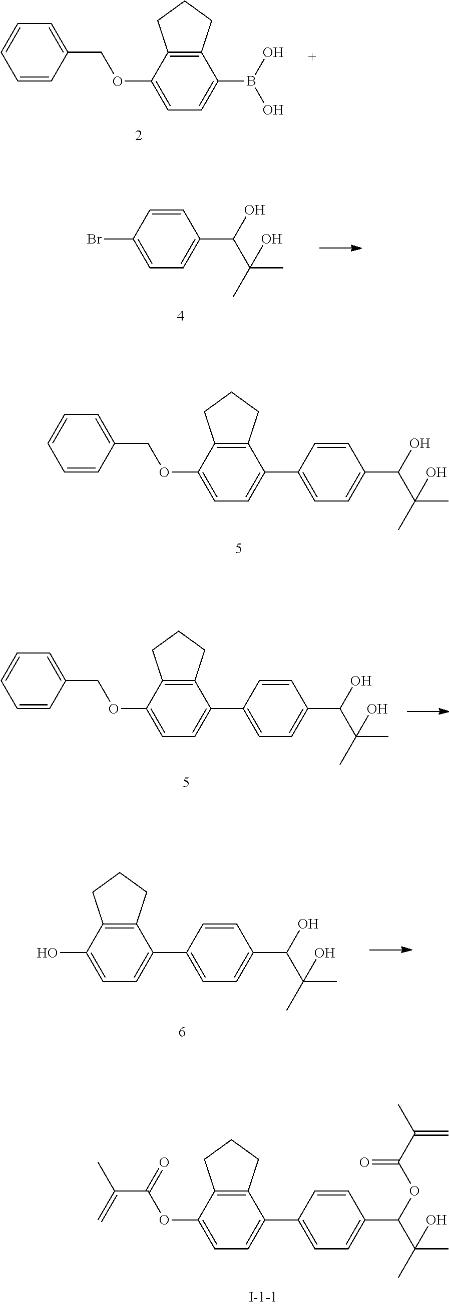

Intermediate 1:21.3 g (0.1 mol) of 7-bromo-2,3-hydro-1H-inden-4-ol, 16.6 g (0.12 mol) of anhydrous potassium carbonate, 15.2 g (0.12 mol) of benzyl chloride, and 0.5 L of N,N-dimethylformamide were put into a 1 L three-necked flask and reacted at a controlled temperature of 120° C. for 4 hours. After cooling to 40° C., the reaction material was poured into 2 L of ice water and vigorously stirred. A brown solid precipitated. After suction filtration, the filter cake was recrystallized with 100 ml of ethanol to give 27.8 g of intermediate 1 as a white solid, with a purity of 98.8% and a yield of 92%.

Intermediate 2:27.8 g (0.092 mol) of intermediate 1 and 100 mL of tetrahydrofuran were added to a 1 L three-necked flask. Under nitrogen protection, the mixture was cooled. At T=−80° C., 40 ml (0.1 mol) of n-butyl lithium was dropwise added over 30 min, and the mixture was reacted for 1 h while the temperature was maintained. At T=−80° C., 10.4 g (0.1 mol) of a solution of trimethyl borate in THF was dropwise added over 20 min, and the mixture was reacted for 1 h while the temperature was maintained. The temperature was allowed to naturally rise. 200 ml of water was added for quenching. Phases were separated. The aqueous phase was extracted with 2×200 mL of ethyl acetate. The organic phases were combined, dried and concentrated to give 18 g of intermediate 2 as a white solid, with a purity of 92.8% and a yield of 73.2%.

Intermediate 3:259.2 g (0.6 mol) of isopropyltriphenylphosphonium iodide and 1000 mL of tetrahydrofuran were added to a 3 L three-necked flask. Under nitrogen protection, the mixture was cooled. At T=0° C., 67.2 g (0.6 mol) of potassium tert-butoxide was added and stirred for 30 min. 92.5 g (0.5 mol) of a solution of p-bromobenzaldehyde in THF was dropwise added. After the dropwise addition was complete, the mixture was reacted for 2 h while the temperature was maintained. 500 ml of water was added for quenching. Phases were separated. The aqueous phase was extracted with 2×300 mL of ethyl acetate. The organic phases were combined, dried and concentrated to give a white solid, which was recrystallized twice with 2 folds (mass ratio) of anhydrous ethanol to give 89.8 g of intermediate 3 as a white solid, with a purity of 93.7% and a yield of 85.1%.

Intermediate 4:21.1 g (0.1 mol) of intermediate 3 and 18.8 g (0.14 mol) of 4-methylmorpholine 4-oxide were added to a 1 L three-necked flask, followed by the addition of 500 ml of acetone and 50 ml of distilled water. The mixture was stirred until uniformly dispersed. An osmium tetroxide aqueous solution having a mass fraction of 4% (13 ml, 0.002 mol) was added and stirred at room temperature for 48 h. 200 ml of water was added. The temperature was controlled at 0° C. 2M HCl was slowly dropwise added until it was weakly acidic. A solid precipitated. The solid was recrystallized with 1 fold of toluene and 2 folds of petroleum ether (weight ratio) to give 16.8 g of intermediate 4 as a white solid, with a purity of 82.9% and a yield of 68.8%.

Intermediate 5:18.2 g (0.068 mol) of intermediate 2, 16.8 g (0.068 mol) of intermediate 4, 11.3 g (0.082 mol) of anhydrous potassium carbonate, 0.3 L of toluene, and 0.1 L of water were added to a 1 L three-necked flask, followed by the addition of a palladium catalyst under nitrogen protection. The mixture was heated under reflux and reacted for 6 hours. After liquid separation, the organic phase was washed with 0.2 L of water. The organic phase was passed through a 50 g silica gel column, and the column was rinsed with 150 g of toluene. The resulting material was dried by rotary evaporation and slurried with 2 folds of petroleum ether (weight ratio) to give 22.1 g of intermediate 5 as a white solid, with a purity of 97.7% and a yield of 83.9%.

Intermediate 6: The intermediate 5 from the previous step, 0.3 L of toluene, 0.1 L of anhydrous ethanol, and 0.2 g of palladium on carbon (5%) were charged into a 1 L three-necked flask, followed by evacuation five times with nitrogen and three times with hydrogen. After hydrogenation for 4 h at room temperature under stirring, the resulting material was filtered to remove the palladium on carbon. After concentration, the resulting material was recrystallized with 1 fold of toluene and 2 folds of petroleum ether (weight ratio) to obtain 13.1 g of intermediate 6 as a white solid, with a purity of 98.9% and a yield of 95%.

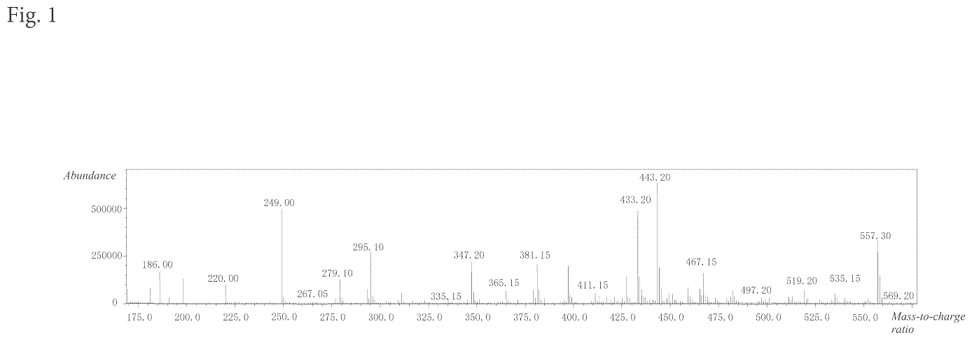

Product I-1-1:13.1 g (0.054 mol) of intermediate 6, 11.6 g (0.135 mol) of methacrylic acid, and 0.5 L of dichloromethane were charged into a 1 L three-necked flask and cooled to 0° C. under nitrogen protection. The temperature was controlled at 0-5° C. 27.8 g (0.135 mol) of DCC was added. After the addition was complete, the mixture was allowed to naturally rise to room temperature and reacted at room temperature for 8 hours. After filtration, insoluble substances were removed. The filtrate was concentrated and recrystallized twice with 2 folds of ethanol and once with 1 fold of toluene and 2 folds of ethanol to give 12.5 g of product I-1-1 as a white solid, with a purity of 99.61%, a yield of 53.2%, and an mp of 81.5° C. The result of a mass spectrum of the product I-1-1 was as shown in FIG. 1.

### Example 2

The structural formula of the polymerizable compound was as represented by the following formula I-1-7:

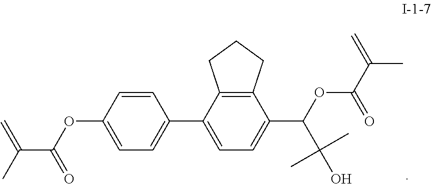 [SMILES: C=C(C)C(=O)Oc1ccc(-c2ccc(C(OC(=O)C(=C)C)C(C)(C)O)c3c2CCC3)cc1]

The preparation route thereof was as follows:

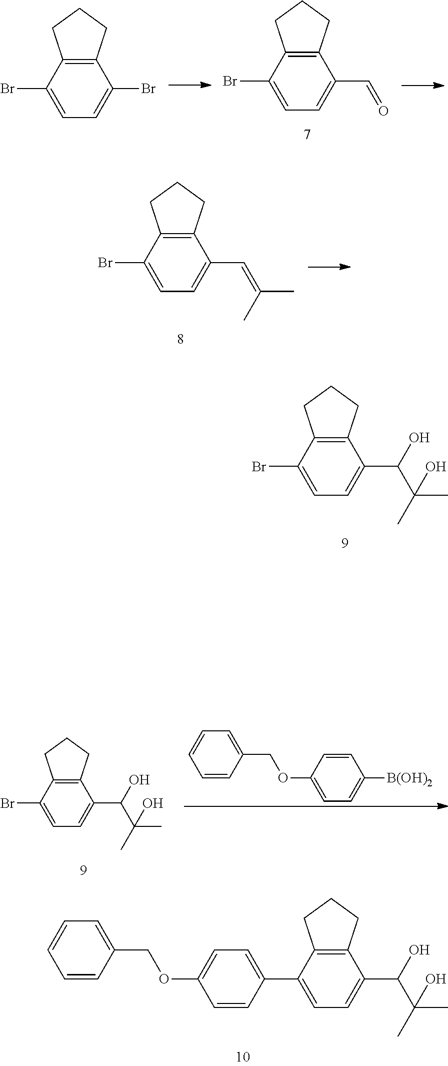

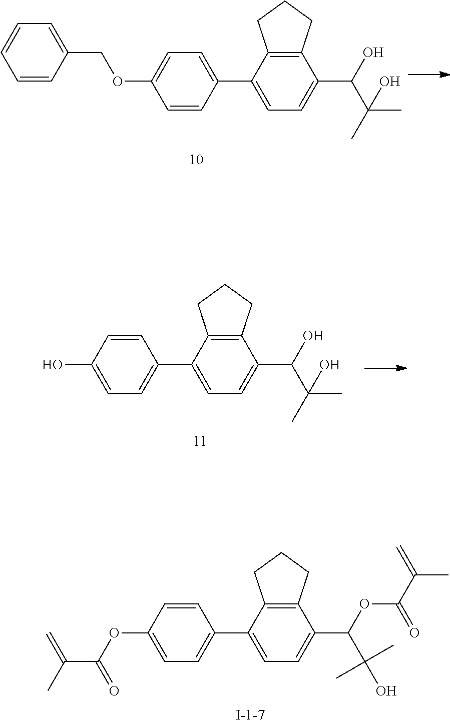

Intermediate 7:137 g (0.5 mol) of 1,7-dibromo-dihydro-indene and 500 mL of tetrahydrofuran were added to a 2 L three-necked flask. Under nitrogen protection, the mixture was cooled. At T=−80° C., 220 ml (0.55 mol) of n-butyl lithium was dropwise added over 30 min, and the mixture was reacted for 1 h while the temperature was maintained. At T=−80° C., 43.8 g (0.6 mol) of a solution of DMF in THF was dropwise added over 30 min, and the mixture was reacted for 1 h while the temperature was maintained. The temperature was allowed to naturally rise. 500 ml of water was added for quenching. Phases were separated. The aqueous phase was extracted with 2×200 mL of ethyl acetate. The organic phases were combined, dried and concentrated to give 66 g of intermediate 7 as a light brown viscous liquid, with a purity of 91.3% and a yield of 58.7%.

Intermediate 8:150.3 g (0.35 mol) of isopropyltriphenylphosphonium iodide and 500 mL of tetrahydrofuran were added to a 2 L three-necked flask. Under nitrogen protection, the mixture was cooled. At T=0° C., 39.2 g (0.35 mol) of potassium tert-butoxide was added and stirred for 30 min. 66 g (0.29 mol) of a solution of intermediate 7 in THF was dropwise added. After the dropwise addition was complete, the mixture was reacted for 2 h while the temperature was maintained. 500 ml of water was added for quenching. Phases were separated. The aqueous phase was extracted with 2×300 mL of ethyl acetate. The organic phases were combined, dried and concentrated to give a white solid, which was recrystallized twice with 200 g of anhydrous ethanol to give 65.3 g of intermediate 8 as a white solid, with a purity of 81.1% and a yield of 91.2%.

Intermediate 9:65.3 g (0.26 mol) of intermediate 8 and 48.8 g (0.36 mol) of 4-methylmorpholine 4-oxide were added to a 2 L three-necked flask, followed by the addition of 1000 ml of acetone and 100 ml of distilled water. The mixture was stirred until uniformly dispersed. An osmium tetroxide aqueous solution having a mass fraction of 4% (33.8 ml, 0.005 mol) was added and stirred at room temperature for 48 h. 500 ml of water was added. The temperature was controlled at 0° C. 2M HCl was slowly dropwise added until it was weakly acidic. A solid precipitated. The solid was recrystallized with 1 fold of toluene and 2 folds of petroleum ether (weight ratio) to give 45.7 g of intermediate 9 as a white solid, with a purity of 88.3% and a yield of 61.7%.

Intermediate 10:45.7 g (0.16 mol) of intermediate 9, 36.5 g (0.16 mol) of 4-benzyloxyphenylboronic acid, 26.5 g (0.19 mol) of anhydrous potassium carbonate, 0.6 L of toluene, and 0.2 L of water were added to a 2 L three-necked flask, followed by the addition of a palladium catalyst under nitrogen protection. The mixture was heated under reflux and reacted for 6 hours. After liquid separation, the organic phase was washed with 0.5 L of water. The organic phase was passed through a 100 g silica gel column, and the column was rinsed with 400 g of toluene. The resulting material was dried by rotary evaporation and slurried with 2 folds of petroleum ether (weight ratio) to give 53.1 g of intermediate 10 as a white solid, with a purity of 91.6% and a yield of 85.5%.

Intermediate 11: The intermediate 5 from the previous step, 0.3 L of toluene, 0.1 L of anhydrous ethanol, and 0.5 g of palladium on carbon (5%) were charged into a 1 L three-necked flask, followed by evacuation five times with nitrogen and three times with hydrogen. After hydrogenation for 4 h at room temperature under stirring, the resulting material was filtered to remove the palladium on carbon. After concentration, the resulting material was recrystallized with 1 fold of toluene and 2 folds of petroleum ether (weight ratio) to obtain 36.3 g of intermediate 11 as a white solid, with a purity of 90.7% and a yield of 87.1%.

Product I-1-7:36.3 g (0.12 mol) of intermediate 11, 25.8 g (0.3 mol) of methacrylic acid, and 0.8 L of dichloromethane were charged into a 2 L three-necked flask and cooled to 0° C. under nitrogen protection. The temperature was controlled at 0-5° C. 61.7 g (0.3 mol) of DCC was added. After the addition was complete, the mixture was allowed to naturally rise to room temperature and reacted at room temperature for 8 hours. After filtration, insoluble substances were removed. The filtrate was concentrated and recrystallized twice with 2 folds of ethanol and once with 1 fold of toluene and 2 folds of ethanol to give 12.5 g of product I-1-7 as a white solid, with a purity of 99.49%, a yield of 53.2%, and an mp of 82.7° C.

### Example 3

The structural formula of the polymerizable compound was as represented by the following formula I-10-1:

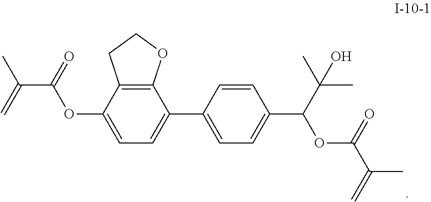 [SMILES: C=C(C)C(=O)Oc1ccc(-c2ccc(C(OC(=O)C(=C)C)C(C)(C)O)cc2)c2c1CCO2]

The preparation route thereof was as follows:

First, common intermediate 12 was synthesized according to the following route:

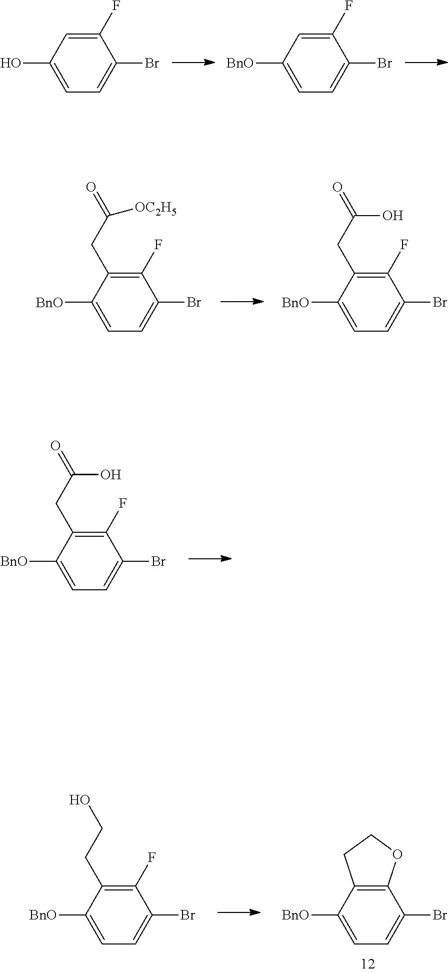

Compound I-10-1 was then synthesized according to the following route:

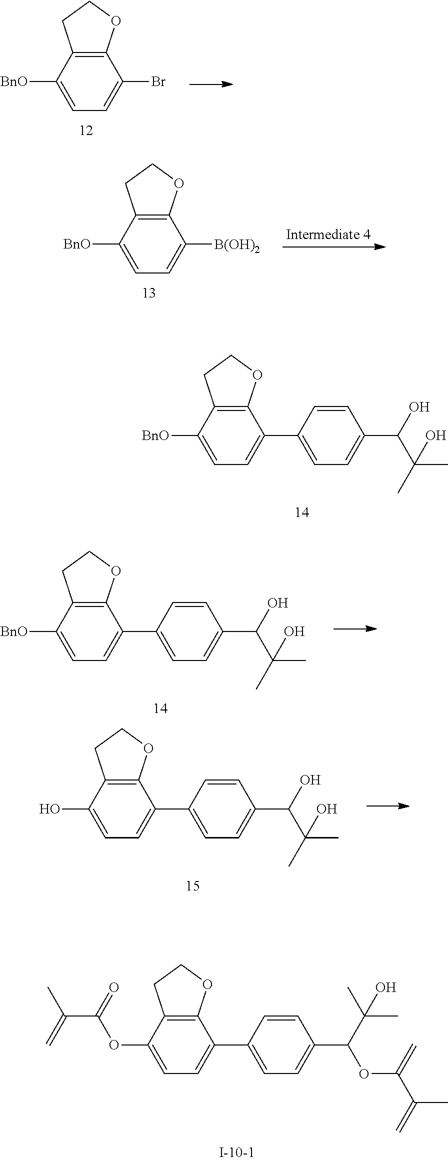

Intermediate 13:15.3 g (0.05 mol) of intermediate 12 and 100 mL of tetrahydrofuran were added to a 0.5 L three-necked flask. Under nitrogen protection, the mixture was cooled. At T=−80° C., 24 ml (0.06 mol) of n-butyl lithium was dropwise added over 20 min, and the mixture was reacted for 1 h while the temperature was maintained. At T=−80° ° C., 6.24 g (0.06 mol) of a solution of trimethyl borate in THF was dropwise added over 150 min, and the mixture was reacted for 1 h while the temperature was maintained. The temperature was allowed to naturally rise. 100 ml of water was added for quenching. Phases were separated. The aqueous phase was extracted with 2×100 mL of ethyl acetate. The organic phases were combined, dried, concentrated, and slurried with 2 folds of petroleum ether (mass ratio) to give 10.8 g of intermediate 13 as a white solid, with a purity of 95.1% and a yield of 78.3%.

Intermediate 14:10.8 g (0.04 mol) of intermediate 13, 9.8 g (0.04 mol) of intermediate 4, 6.6 g (0.048 mol) of anhydrous potassium carbonate, 210 ml of toluene, and 70 ml of water were added to a 0.51 L three-necked flask, followed by the addition of a palladium catalyst under nitrogen protection. The mixture was heated under reflux and reacted for 6 hours. After liquid separation, the organic phase was washed with 100 ml of water. The organic phase was passed through a silica gel column, and the column was rinsed with 80 g of toluene. The resulting material was dried by rotary evaporation and slurried with 2 folds of petroleum ether (weight ratio) to give 12.7 g of intermediate 14 as a white solid, with a purity of 93.6% and a yield of 81.6%.

Intermediate 15:12.7 g of intermediate 14, 150 ml of toluene, 150 ml of anhydrous ethanol, and 0.25 g of palladium on carbon (5%) were charged into a 1 L three-necked flask, followed by evacuation five times with nitrogen and three times with hydrogen. After hydrogenation for 4 h at room temperature under stirring, the resulting material was filtered to remove the palladium on carbon. After concentration, the resulting material was recrystallized with 1 fold of toluene and 2 folds of petroleum ether (weight ratio) to obtain 8.9 g of intermediate 15 as a white solid, with a purity of 96.2% and a yield of 93.1%.

Product I-10-1:8.9 g (0.03 mol) of intermediate 15, 6.3 g (0.075 mol) of methacrylic acid, and 100 ml of dichloromethane were charged into a 1 L three-necked flask and cooled to 0° C. under nitrogen protection. The temperature was controlled at 0-5° C. 15.4 g (0.075 mol) of DCC was added. After the addition was complete, the mixture was allowed to naturally rise to room temperature and reacted at room temperature for 8 hours. After filtration, insoluble substances were removed. The filtrate was concentrated and recrystallized twice with 2 folds of ethanol and once with 1 fold of toluene and 2 folds of ethanol to give 8.3 g of product I-10-1 as a white solid, with a purity of 99.72%, a yield of 63.7%, and an mp of 91.7° C.

### Example 4

The structural formula of the polymerizable compound was as represented by the following formula I-26-1:

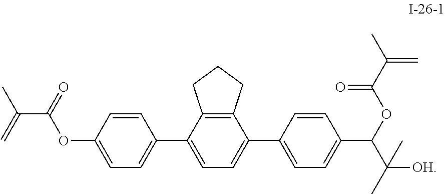 [SMILES: C=C(C)C(=O)Oc1ccc(-c2ccc(-c3ccc(C(OC(=O)C(=C)C)C(C)(C)O)cc3)c3c2CCC3)cc1]

The preparation route thereof was as follows:

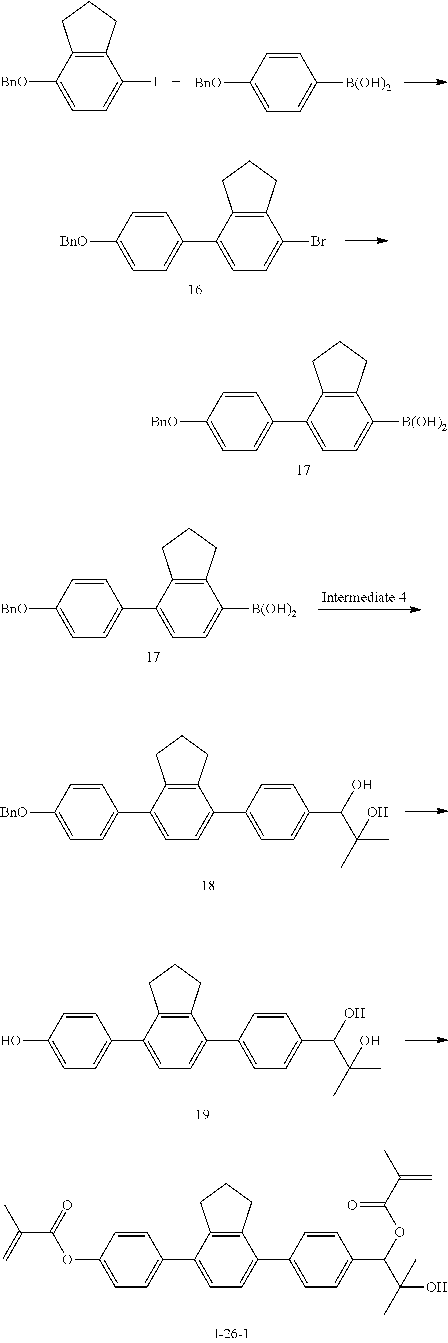

Intermediate 16:16.2 g (0.05 mol) of 4-bromo-7-iodo-2,3-dihydro-indene, 11.4 g (0.05 mol) of 4-benzyloxyphenylboronic acid, 8.28 g (0.06 mol) of anhydrous potassium carbonate, 300 ml of toluene, and 100 ml of water were added to a 0.5 L three-necked flask, followed by the addition of a palladium catalyst under nitrogen protection. The mixture was heated under reflux and reacted for 6 hours. After liquid separation, the organic phase was washed with 100 ml of water. The organic phase was passed through a silica gel column, and the column was rinsed with 100 g of toluene. The resulting material was dried by rotary evaporation, dissolved with 20 folds of petroleum ether under heating, and passed through a silica gel column, and the column was rinsed with 10 folds of hot petroleum ether. After concentration, the resulting material was slurried with 2 folds of petroleum ether (weight ratio) to give 11.8 g of intermediate 16 as a white solid, with a purity of 95.6% and a yield of 62.1%.

Intermediate 17:11.8 g (0.031 mol) of intermediate 16 and 200 mL of tetrahydrofuran were added to a 1 L three-necked flask. Under nitrogen protection, the mixture was cooled. At T=−80° C., 15 ml (0.037 mol) of n-butyl lithium was dropwise added over 20 min, and the mixture was reacted for 1 h while the temperature was maintained. At T=−80° C., 3.8 g (0.037 mol) of a solution of trimethyl borate in THF was dropwise added over 150 min, and the mixture was reacted for 1 h while the temperature was maintained. The temperature was allowed to naturally rise. 100 ml of water was added for quenching. Phases were separated. The aqueous phase was extracted with 2×200 mL of ethyl acetate. The organic phases were combined, dried, concentrated, and slurried with 2 folds of petroleum ether (mass ratio) to give 7.9 g of intermediate 17 as a white solid, with a purity of 90.8% and a yield of 73.9%.

Intermediate 18:7.9 g (0.023 mol) of intermediate 17, 5.6 g (0.023 mol) of intermediate 4, 3.8 g (0.028 mol) of anhydrous potassium carbonate, 500 ml of toluene, and 170 ml of water were added to a 1 L three-necked flask, followed by the addition of a palladium catalyst under nitrogen protection. The mixture was heated under reflux and reacted for 6 hours. After liquid separation, the organic phase was washed with 100 ml of water. The organic phase was passed through a silica gel column, and the column was rinsed with 200 g of toluene. The resulting material was dried by rotary evaporation and slurried with 2 folds of petroleum ether (weight ratio) to give 9 g of intermediate 18 as a white solid, with a purity of 87.6% and a yield of 84.6%.

Intermediate 19:9 g of intermediate 18, 300 ml of toluene, 100 ml of anhydrous ethanol, and 0.2 g of palladium on carbon (5%) were added to a 1 L three-necked flask, followed by evacuation five times with nitrogen and three times with hydrogen. After hydrogenation for 7 h at room temperature under stirring, the resulting material was filtered to remove the palladium on carbon. After concentration, the resulting material was recrystallized with 3 folds of toluene (weight ratio) to obtain 6.8 g of intermediate 19 as a white solid, with a purity of 93.3% and a yield of 95.8%.

Product I-26-1:6.8 g (0.018 mol) of intermediate 19, 3.8 g (0.045 mol) methacrylic acid, and 250 ml of dichloromethane were charged into a 500 ml three-necked flask and cooled to 0° C. under nitrogen protection. The temperature was controlled at 0-5° C. 9.3 g (0.045 mol) of DCC was added. After the addition was complete, the mixture was allowed to naturally rise to room temperature and reacted at room temperature for 8 hours. After filtration, insoluble substances were removed. The filtrate was concentrated and recrystallized twice with 1 fold of toluene and 2 folds of ethanol and once with 3 folds of toluene and 1 fold of petroleum ether to give 5.1 g of product I-26-1 as a white solid, with a purity of 99.07%, a yield of 55.5%, and an mp of 122.5° C.

### Example 5

The structural formula of the polymerizable compound was as represented by the following formula I-38-2:

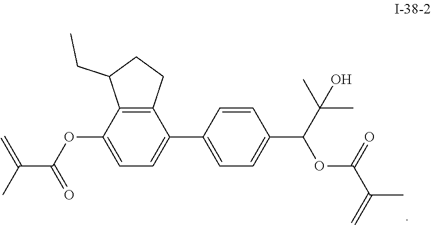 [SMILES: C=C(C)C(=O)Oc1ccc(-c2ccc(C(OC(=O)C(=C)C)C(C)(C)O)cc2)c2c1C(CC)CC2]

The preparation route thereof was as follows:

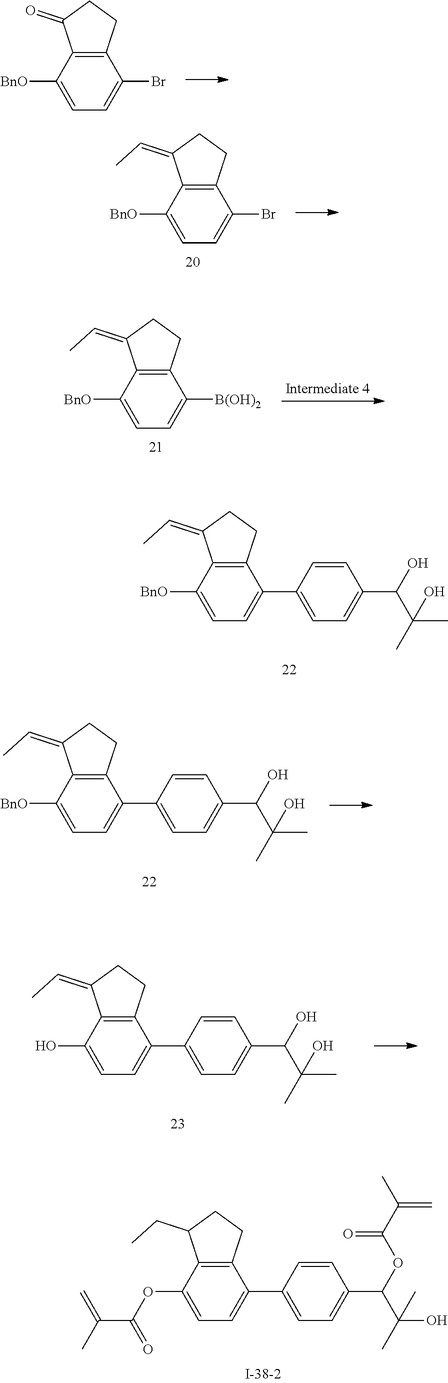

Intermediate 20:22.5 g (0.06 mol) of ethyltriphenylphosphonium bromide was added to a 0.5 L three-necked flask, followed by the addition of 100 ml of tetrahydrofuran. The temperature was controlled at −10° C. 6.7 g (0.06 mol) of potassium tert-butoxide was added and stirred for 1 h while the temperature was maintained. 16 g (0.05 mol) 4-bromo-7-benzyloxy-2,3-dihydro-1-indenone was dissolved in 80 g of tetrahydrofuran and slowly dropwise added to a reaction flask. After the dropwise addition was complete, an ice bath was removed. The temperature was allowed to naturally rise. The mixture was reacted at room temperature for 2 h. 200 ml of water was added and stirred. After liquid separation, the aqueous phase was extracted with 2×100 ml of ethyl acetate. The organic phases were combined, washed with 2×100 ml of water, dried over 20 g of anhydrous sodium sulfate, concentrated in vacuo, and recrystallized four times with 2 folds of ethanol (weight ratio) to obtain 8.7 g of intermediate 20 as a white solid, with a purity of 99.1% and a yield of 54%.

Intermediate 21:8.7 g (0.026 mol) of intermediate 20 and 100 mL of tetrahydrofuran were added to a 0.5 L three-necked flask. Under nitrogen protection, the mixture was cooled. At T=−80° C., 14 ml (0.034 mol) of n-butyl lithium was dropwise added over 30 min, and the mixture was reacted for 1 h while the temperature was maintained. At T=−80° ° C., 3.6 g (0.035 mol) of a solution of trimethyl borate in THF was dropwise added over 20 min, and the mixture was reacted for 1 h while the temperature was maintained. The temperature was allowed to naturally rise. 100 ml of water was added for quenching. Phases were separated. The aqueous phase was extracted with 2×100 mL of ethyl acetate. The organic phases were combined, dried and concentrated to give 5 g of intermediate 21 as a white solid, with a purity of 93.3% and a yield of 65%.

Intermediate 22:5 g (0.017 mol) of intermediate 21, 4 g (0.016 mol) of intermediate 4, 2.9 g (0.021 mol) of anhydrous potassium carbonate, 0.12 L of toluene, and 0.4 L of water were added to a 0.5 L three-necked flask, followed by the addition of a palladium catalyst under nitrogen protection. The mixture was heated under reflux and reacted for 6 hours. After liquid separation, the organic phase was washed with 0.1 L of water. The organic phase was passed through a 20 g silica gel column, and the column was rinsed with 100 g of toluene. The resulting material was dried by rotary evaporation and slurried with 2 folds of petroleum ether (weight ratio) to give 5.2 g of intermediate 22 as a white solid, with a purity of 90.4% and a yield of 78.8%.

Intermediate 23: The intermediate 22 from the previous step, 0.1 L of toluene, 0.05 L of anhydrous ethanol, and 0.1 g of palladium on carbon (5%) were charged into a 0.5 L three-necked flask, followed by evacuation five times with nitrogen and three times with hydrogen. After hydrogenation for 4 h at room temperature under stirring, the resulting material was filtered to remove the palladium on carbon. After concentration, the resulting material was recrystallized with 1 fold of toluene and 2 folds of petroleum ether (weight ratio) to obtain 4 g of intermediate 23 as a white solid, with a purity of 94.3% and a yield of 97%.

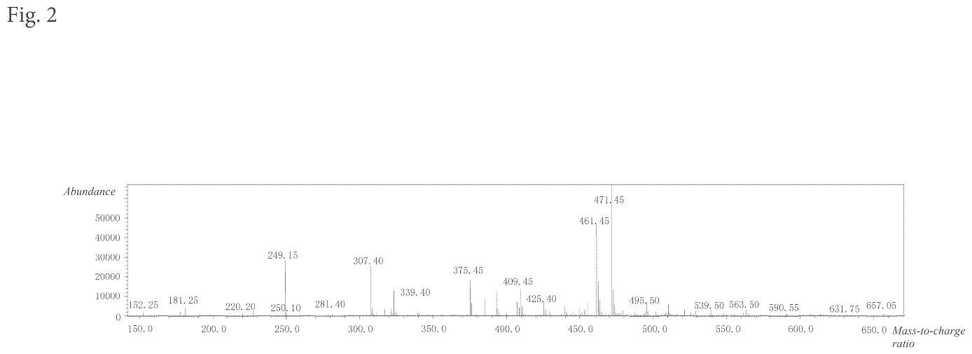

Product I-38-2:4 g (0.0123 mol) of intermediate 23, 2.74 g (0.032 mol) of methacrylic acid, and 0.1 L of dichloromethane were charged into a 0.5 L three-necked flask and cooled to 0° C. under nitrogen protection. The temperature was controlled at 0-5° C. 0.56 g (0.0032 mol) of DCC was added. After the addition was complete, the mixture was allowed to naturally rise to room temperature and reacted at room temperature for 8 hours. After filtration, insoluble substances were removed. The filtrate was concentrated and recrystallized twice with 2 folds of ethanol and once with 1 fold of toluene and 2 folds of ethanol to give 3 g of product I-38-2 as a white solid, with a purity of 99.77%, a yield of 53.6%, and an mp of 83.7° C. The result of a mass spectrum of the product I-38-2 was as shown in FIG. 2.

### Examples 6-26

Following the synthesis methods of Examples 1-4, the following examples were synthesized by simply replacing raw materials:

### Example 6

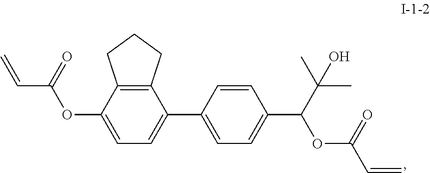 [SMILES: C=CC(=O)Oc1ccc(-c2ccc(C(OC(=O)C=C)C(C)(C)O)cc2)c2c1CCC2]

### Example 7

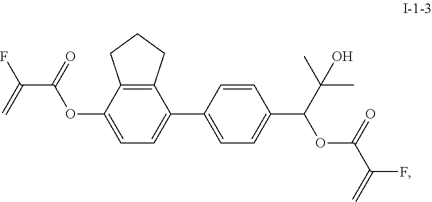 [SMILES: C=C(F)C(=O)Oc1ccc(-c2ccc(C(OC(=O)C(=C)F)C(C)(C)O)cc2)c2c1CCC2]

### Example 8

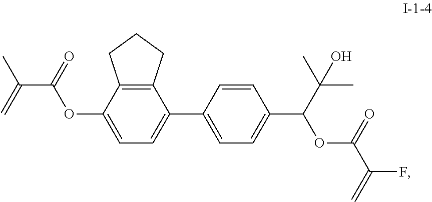 [SMILES: C=C(C)C(=O)Oc1ccc(-c2ccc(C(OC(=O)C(=C)F)C(C)(C)O)cc2)c2c1CCC2]

### Example 9

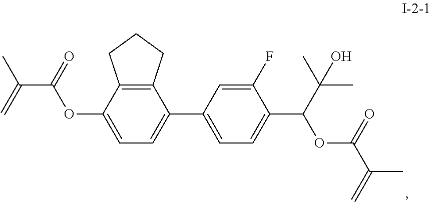 [SMILES: C=C(C)C(=O)Oc1ccc(-c2ccc(C(OC(=O)C(=C)C)C(C)(C)O)c(F)c2)c2c1CCC2]

### Example 10

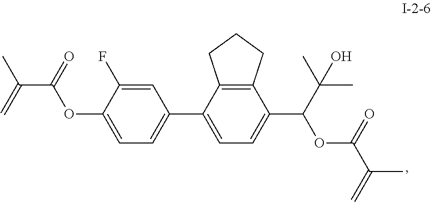 [SMILES: C=C(C)C(=O)Oc1ccc(-c2ccc(C(OC(=O)C(=C)C)C(C)(C)O)c3c2CCC3)cc1F]

### Example 11

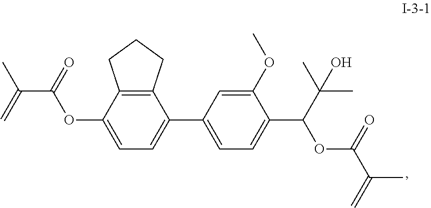 [SMILES: C=C(C)C(=O)Oc1ccc(-c2ccc(C(OC(=O)C(=C)C)C(C)(C)O)c(OC)c2)c2c1CCC2]

### Example 12

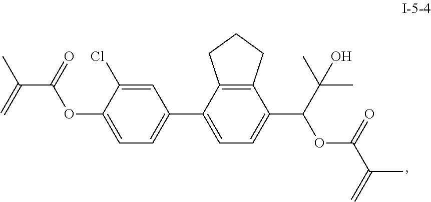 [SMILES: C=C(C)C(=O)Oc1ccc(-c2ccc(C(OC(=O)C(=C)C)C(C)(C)O)c3c2CCC3)cc1Cl]

### Example 13

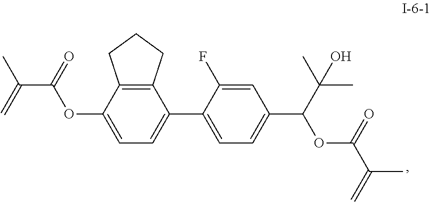 [SMILES: C=C(C)C(=O)Oc1ccc(-c2ccc(C(OC(=O)C(=C)C)C(C)(C)O)cc2F)c2c1CCC2]

### Example 14

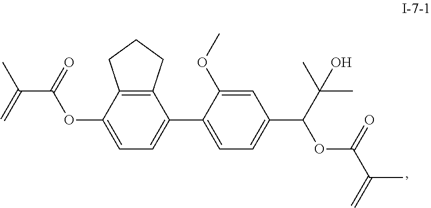 [SMILES: C=C(C)C(=O)Oc1ccc(-c2ccc(C(OC(=O)C(=C)C)C(C)(C)O)cc2OC)c2c1CCC2]

### Example 15

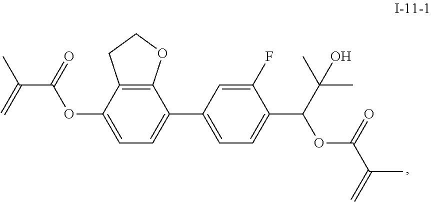 [SMILES: C=C(C)C(=O)Oc1ccc(-c2ccc(C(OC(=O)C(=C)C)C(C)(C)O)c(F)c2)c2c1CCO2]

### Example 16

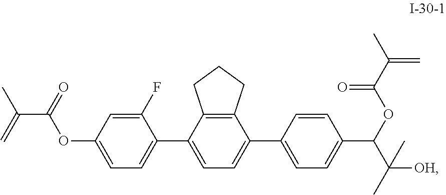 [SMILES: C=C(C)C(=O)Oc1ccc(-c2ccc(-c3ccc(C(OC(=O)C(=C)C)C(C)(C)O)cc3)c3c2CCC3)c(F)c1]

### Example 17

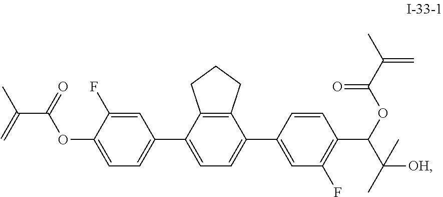 [SMILES: C=C(C)C(=O)Oc1ccc(-c2ccc(-c3ccc(C(OC(=O)C(=C)C)C(C)(C)O)c(F)c3)c3c2CCC3)cc1F]

### Example 18

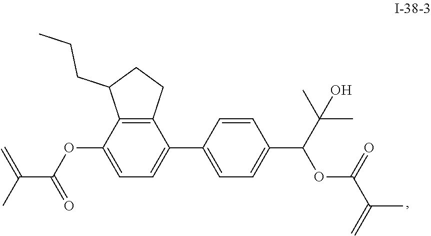 [SMILES: C=C(C)C(=O)Oc1ccc(-c2ccc(C(OC(=O)C(=C)C)C(C)(C)O)cc2)c2c1C(CCC)CC2]

### Example 19

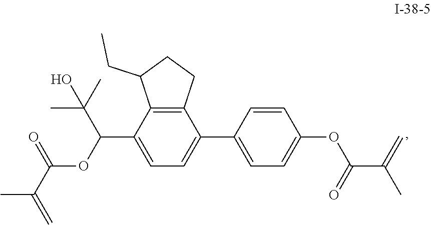 [SMILES: C=C(C)C(=O)Oc1ccc(-c2ccc(C(OC(=O)C(=C)C)C(C)(C)O)c3c2CCC3CC)cc1]

### Example 20

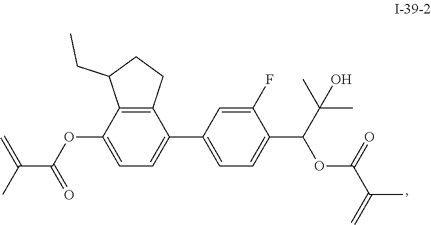 [SMILES: C=C(C)C(=O)Oc1ccc(-c2ccc(C(OC(=O)C(=C)C)C(C)(C)O)c(F)c2)c2c1C(CC)CC2]

### Example 21

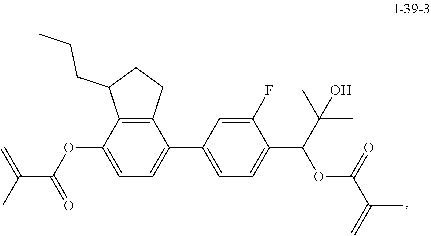 [SMILES: C=C(C)C(=O)Oc1ccc(-c2ccc(C(OC(=O)C(=C)C)C(C)(C)O)c(F)c2)c2c1C(CCC)CC2]

### Example 22

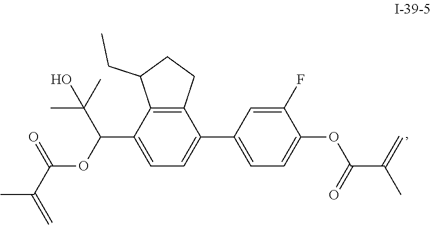 [SMILES: C=C(C)C(=O)Oc1ccc(-c2ccc(C(OC(=O)C(=C)C)C(C)(C)O)c3c2CCC3CC)cc1F]

### Example 23

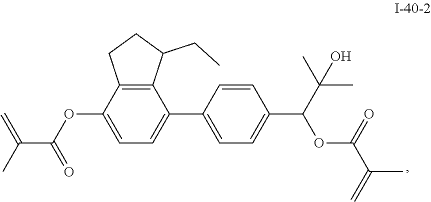 [SMILES: C=C(C)C(=O)Oc1ccc(-c2ccc(C(OC(=O)C(=C)C)C(C)(C)O)cc2)c2c1CCC2CC]

### Example 24

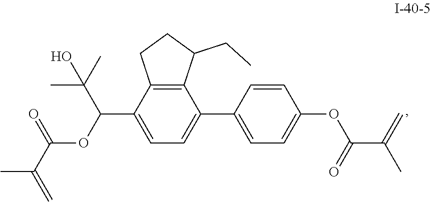 [SMILES: C=C(C)C(=O)Oc1ccc(-c2ccc(C(OC(=O)C(=C)C)C(C)(C)O)c3c2C(CC)CC3)cc1]

### Example 25

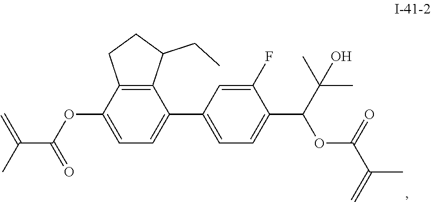 [SMILES: C=C(C)C(=O)Oc1ccc(-c2ccc(C(OC(=O)C(=C)C)C(C)(C)O)c(F)c2)c2c1CCC2CC]

### and Example 26

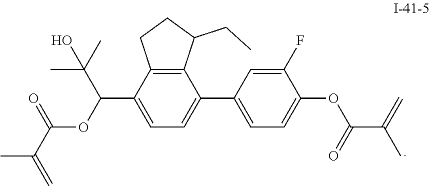 [SMILES: C=C(C)C(=O)Oc1ccc(-c2ccc(C(OC(=O)C(=C)C)C(C)(C)O)c3c2C(CC)CC3)cc1F]

The following seven representative monomers were selected from the examples for experiments:

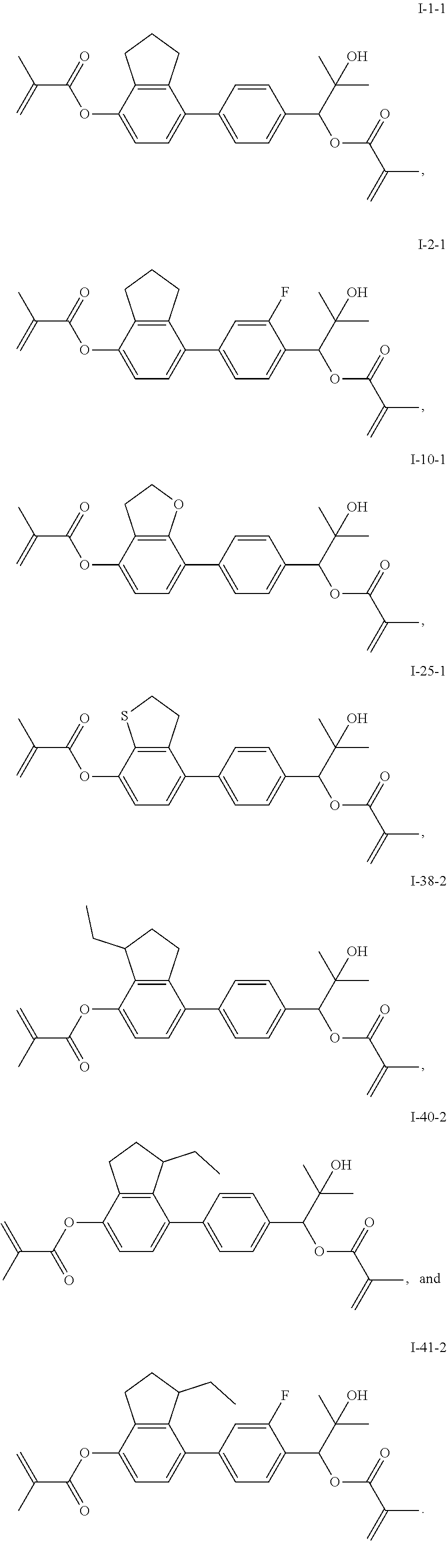

### Comparative Polymerizable Compounds:

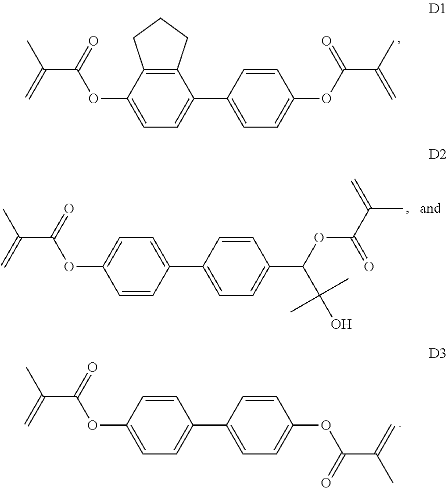

The compositions and performance parameters of compounds SLC-1, SLC-2, and SLC-3 were as shown in Tables 3 and 4, respectively.

TABLE 3
Composition of compounds SLC-1, SLC-2, and SLC-3

| | | Content (wt %) | | |
|---|---|---|---|---|
| Category | Code | SLC-1 | SLC-2 | SLC-3 |
| IV | CCP-3-1 | 9 | | 6 |
| III | CPY-3-O2 | 6 | 10 | 10 |
| III | CCOY-3-O2 | 10 | | |
| VI | CGPC-3-3 | 2 | 2 | 3 |
| II | CC-5-3 | | 4 | 4 |
| III | CY-3-O2 | | 15 | 15 |
| III | CY-5-O2 | | 10 | 10 |
| III | CCY-3-O2 | | 7 | 6 |
| II | CC-3-V1 | | 8 | 8 |
| II | CC-4-3 | 6 | 8 | 6 |
| III | CCY-2-O2 | | 3 | 4 |
| III | CCY-4-O2 | | 5 | 5 |
| III | CPY-4-O2 | 4 | | |
| III | CPY-2-O2 | 9 | 8 | 8 |
| III | CY-3-O4 | | 3 | 3 |
| II | PP-1-2V1 | | 5 | 4 |
| II | CC-2-3 | 19 | 4 | |
| II | CC-3-V | | | 5 |
| III | COY-3-O2 | 10 | | |
| III | COY-3-O1 | 5 | | |
| III | CCOY-2-O2 | 6 | | |
| V | S-CpO-O4 | 4 | | |
| V | S-CpO-O2 | | 3 | 3 |
| II | PP-1-3 | 6 | | |
| IV | CLP-3-1 | 4 | 5 | |

TABLE 4
Performance parameters of compositions SLC-1 to SLC-3

| Performance | SLC-1 | SLC-2 | SLC-3 |
|---|---|---|---|
| Cp (° C.) | 90.2 | 89.8 | 89.5 |
| Δn (25° C., 589 nm) | 0.1032 | 0.1035 | 0.1030 |
| Δε (25° C., 1 KHz) | −3.9 | −3.9 | −3.8 |
| ε_{⊥} (25° C., 1 KHz) | 7.6 | 7.5 | 7.4 |
| γ₁ (25° C., mPa · s) | 113.4 | 112.4 | 105.8 |
| K₁₁ (25° C., 1 KHz) | 16.0 | 16.3 | 15.8 |
| K₃₃ (25° C., 1 KHz) | 16.6 | 16.8 | 16.2 |
| γ₁/K₃₃ | 7.08 | 6.89 | 6.53 |

### Examples of Polymerizable Liquid Crystal Compositions

The corresponding polymerizable liquid crystal compositions were prepared by separately adding seven representative monomers of polymerizable compounds I-1-1 to I-41-2 at a concentration of 0.3% by weight to the compositions SLC-1, SLC-2, and SLC-3.

For the purpose of comparison, the corresponding polymerizable liquid crystal compositions were prepared by separately adding polymerizable compounds D1, D2, and D3 in the prior art at a concentration of 0.3% by weight to the liquid crystal compositions SLC-1, SLC-2, and SLC-3.

The structure of the self-aligning agent used in the examples and comparative examples for a PI-free diffusivity test was as shown in the following formula:

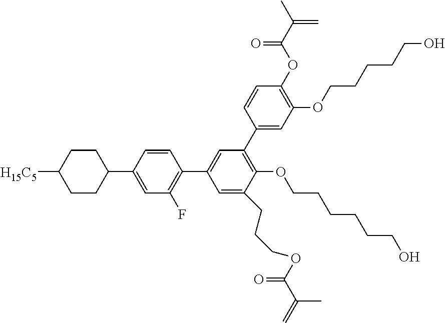

It is well known that existing SAVA-mode displays have no conventional polyimide alignment films, which achieve alignment effects by using so-called self-aligning additives for vertical alignment. To more accurately simulate the diffusivity of RMs in a PI-free test cell, the SAVA self-aligning agent having the above representative structure was added to all the examples and comparative examples. The content of the self-aligning agent added had a concentration of 1.0% by weight of the SLC composition.

TABLE 5
Diffusivity data of examples and comparative examples in SLC-1
composition

| | I-1- | I-2- | I-10- | I-25- | I-38- | I-40- | I-41- | | | |
|---|---|---|---|---|---|---|---|---|---|---|
| | 1 | 1 | 1 | 1 | 2 | 2 | 2 | D1 | D2 | D3 |
| Diffusivity | 15 | 25 | 22 | 21 | 20 | 24 | 25 | 75 | 50 | 62 |
| (Δ: ppm, | | | | | | | | | | |
| with PI) | | | | | | | | | | |
| Diffusivity | 20 | 28 | 26 | 25 | 25 | 28 | 29 | 82 | 56 | 70 |
| (Δ: ppm, | | | | | | | | | | |
| without PI) | | | | | | | | | | |

TABLE 6
Diffusivity data of examples and comparative examples in SLC-3
composition

| | I-1- | I-2- | I-10- | I-25- | I-38- | I-40- | I-41- | | | |
|---|---|---|---|---|---|---|---|---|---|---|
| | 1 | 1 | 1 | 1 | 2 | 2 | 2 | D1 | D2 | D3 |
| Diffusivity | 17 | 25 | 20 | 22 | 22 | 25 | 26 | 74 | 52 | 60 |
| (Δ: ppm, | | | | | | | | | | |
| with PI) | | | | | | | | | | |
| Diffusivity | 21 | 30 | 25 | 27 | 26 | 29 | 30 | 80 | 57 | 70 |
| (Δ: ppm, | | | | | | | | | | |
| without PI) | | | | | | | | | | |

As can be seen from Tables 5 and 6, in test cells with and without PI, the diffusivities of the examples were all superior to those of the comparative examples, and the diffusivities Δ of the examples were all 30 ppm or less (with and without PI), whereas the diffusivities Δ of the comparative examples were all 50 ppm or more (with and without PI), and the diffusivity Δ of D1 was even 70 ppm or more (with and without PI). Therefore, the polymerizable compound involved had the advantage of good diffusivity. This indicates that the probability of Zara Particle formation by runaway polymerization from RMs in the examples in displays with various modes is greatly reduced, which is beneficial to improving the display effect of the displays.

In this experiment, the extreme conditions were low-temperature treatment at −20° C. for 500 h, high-temperature treatment at 85° C. for 500 h, high- and low-temperature cycling treatment for 500 h (−20° C., 2.5 h; 85° C., 2.5 h; 100 cycles), and high temperature 85° C.-humidity 85% (high temperature and high humidity) treatment for 500 h.

TABLE 7
Performance parameters of examples and comparative examples in SLC-1
composition

| | | I-1- | I-2- | I-10- | I-25- | I-38- | I-40- | I-41- | | | |
|---|---|---|---|---|---|---|---|---|---|---|---|
| | | 1 | 1 | 1 | 1 | 2 | 2 | 2 | D1 | D2 | D3 |
| IS after | IS after | No | No | No | No | No | No | No | ND | ND | ND |
| different | low- | IS | IS | IS | IS | IS | IS | IS | 9 | 9 | 8 |
| conditions | temperature | | | | | | | | | | |
| | aging | | | | | | | | | | |
| | IS after | No | No | ND | ND | No | ND | No | ND | ND | ND |
| | high- | IS | IS | 10 | 10 | IS | 10 | IS | 8 | 8 | 7 |
| | temperature | | | | | | | | | | |
| | and high- | | | | | | | | | | |
| | humidity | | | | | | | | | | |
| | aging | | | | | | | | | | |
| | IS after | No | No | No | No | No | No | No | ND | ND | ND |
| | high- | IS | IS | IS | IS | IS | IS | IS | 8 | 9 | 8 |
| | temperature | | | | | | | | | | |
| | aging | | | | | | | | | | |
| | IS after | No | No | ND | No | No | No | No | ND | ND | ND |
| | high- | IS | IS | 10 | IS | IS | IS | IS | 8 | 9 | 8 |
| | and low- | | | | | | | | | | |
| | temperature | | | | | | | | | | |
| | cycling | | | | | | | | | | |

| | | | | | | | | | | |
|---|---|---|---|---|---|---|---|---|---|---|
| UV2 time (min) | 90 | 90 | 90 | 90 | 90 | 90 | 90 | 90 | 90 | 90 |
| PA (°) | 88.5 | 88.4 | 88.5 | 88.4 | 88.5 | 88.6 | 88.5 | 88.5 | 88.4 | 88.5 |
| RM residual | 16 | 20 | 18 | 15 | 17 | 14 | 18 | 80 | 45 | 105 |
| (ppm) | | | | | | | | | | |

TABLE 8
Performance parameters of examples and comparative examples in SLC-2
composition

| | | I-1- | I-2- | I-10- | I-25- | I-38- | I-40- | I-41- | | | |
|---|---|---|---|---|---|---|---|---|---|---|---|
| | | 1 | 1 | 1 | 1 | 2 | 2 | 2 | D1 | D2 | D3 |
| IS after | IS after | No | No | No | No | No | No | No | ND | ND | ND |
| different | low- | IS | IS | IS | IS | IS | IS | IS | 9 | 9 | 8 |
| conditions | temperature | | | | | | | | | | |
| | aging | | | | | | | | | | |
| | IS after | No | ND | ND | ND | No | ND | No | ND | ND | ND |
| | high- | IS | 10 | 10 | 10 | IS | 10 | IS | 8 | 8 | 7 |
| | temperature | | | | | | | | | | |
| | and high- | | | | | | | | | | |
| | humidity | | | | | | | | | | |
| | aging | | | | | | | | | | |
| | IS after | No | No | No | No | No | No | No | ND | ND | ND |
| | high- | IS | IS | IS | IS | IS | IS | IS | 8 | 9 | 7 |
| | temperature | | | | | | | | | | |
| | aging | | | | | | | | | | |
| | IS after | No | No | No | ND | ND | No | No | ND | ND | ND |
| | high- and | IS | IS | IS | 10 | 10 | IS | IS | 8 | 9 | 8 |
| | low- | | | | | | | | | | |
| | temperature | | | | | | | | | | |
| | cycling | | | | | | | | | | |

| | | | | | | | | | | |
|---|---|---|---|---|---|---|---|---|---|---|
| UV2 time (min) | 90 | 90 | 90 | 90 | 90 | 90 | 90 | 90 | 90 | 90 |
| PA (°) | 88.6 | 88.5 | 88.5 | 88.6 | 88.4 | 88.5 | 88.4 | 88.5 | 88.5 | 88.6 |
| RM residual | 15 | 19 | 18 | 18 | 20 | 19 | 18 | 72 | 40 | 100 |
| (ppm) | | | | | | | | | | |

As can be seen from Tables 7 and 8, under the condition of a fixed UV2 time of 90 min and a final pretilt angle of 1.5°, the RM residual amount of the polymerizable compound in each of the examples was essentially less than 20 ppm, whereas the comparative examples all showed residual amounts of 40 ppm or more, and D3 showed a residual amount of 100 ppm or more. Compared with the polymerizable compounds of the comparative examples, the polymerizable compound in each of the examples exhibited less polymer residue. The polymerizable compounds of the present invention exhibited low residue after the UV process, and a lower polymer residue showed obvious positive effects on improving the display effect of the display. From the IS data after low-temperature aging, high-temperature and high-humidity aging, high-temperature aging, and high- and low-temperature cycling for 500 h, it can be found that the IS performance of each RM monomer after high-temperature and high-humidity aging was the worst. This indicates that under these conditions, the stability of RM was relatively poor; however, under each extreme condition, the IS performance of the liquid crystal composition of each of the examples was superior to that of the comparative examples, and the image sticking level of the liquid crystal composition in each of the examples was ND10 or more (ND10 or no IS), greatly reducing the risk of the problem of image sticking on the final display. Upon analysis from a chemical structure perspective, when a fused cyclic group having electron-donating functionality was introduced into a polymerizable compound having biphenyl in which phenyl rings are directly linked; moreover, the electron cloud density of the molecule increases due to the electron-donating effect, the polymerization reaction was faster and the residue was lower. Therefore, the polymerizable compound of the present invention can have the characteristics of low residue after the UV process and excellent IS performance under extreme conditions while exhibiting good diffusivity.

In summary, the present invention provides a polymerizable compound represented by formula I containing a benzene-fused ring system in the main ring and necessarily a tertiary alcohol branch structure, and a liquid crystal composition formed with the polymerizable compound combined with a specific liquid crystal component. The polymerizable compound exhibits the advantages of good diffusivity and low residue after the UV process. Furthermore, it is ensured that displays utilizing the polymerizable compound remain excellent IS performance after extreme conditions (high temperature, low temperature, high- and low-temperature cycling, and high temperature and high humidity), and the risk of problems such as image sticking on the final display is reduced, so that a liquid crystal display device having more excellent quality can be provided.

Apparently, the above examples of the present invention are only examples provided to clearly illustrate the present invention, rather than limitations on the embodiments of the present invention. For those of ordinary skill in the art, other variations or changes in various forms can also be made on the basis of the above description. It is impossible to enumerate all embodiments here. Any obvious variations or changes arising from the technical solutions of the present invention still fall within the scope of protection of the present invention.

1. A polymerizable compound, characterized in that the polymerizable compound is a compound represented by the following formula I: 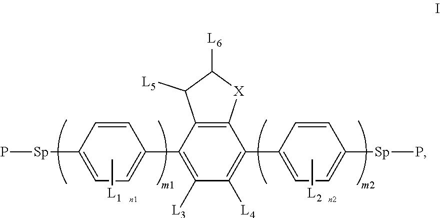
wherein
L₁ and L₂ are each independently selected from H, C1-C5 alkyl or alkoxy, C2-C5 alkenyl or alkenoxy, fluorine-substituted C1-C5 alkyl or alkoxy, fluorine-substituted C2-C5 alkenyl or alkenoxy, and halogen, wherein any one or more non-adjacent —CH₂— can be each independently replaced by —O—, —S—, —CO—, —CH₂O—, —OCH₂—, —COO—, —OOC—, or —Sp—;
L₃, L₄, L₅, and Le are each independently selected from H, C1-C5 alkyl or alkoxy, C2-C5 alkenyl or alkenoxy, fluorine-substituted C1-C5 alkyl or alkoxy, fluorine-substituted C2-C5 alkenyl or alkenoxy, and halogen;
n₁ and n₂ each independently represent 0, 1, 2, 3, or 4;
m₁ and m₂ each independently represent 0 or 1, and m₁ and m₂ are not both 0;
each occurrence of P independently represents an acrylate group, a methacrylate group, or a fluoroacrylate group;
Sp represents a single bond or a C1-C5 linear, branched or cyclic alkyl group, and the Sp groups are not both single bonds, wherein any one or more non-adjacent —CH₂— can be replaced by —O—, —S—, —CO—, —CH₂O—, —OCH₂—, —COO—, —OOC—, or an acrylate group in such a manner that O- or S-atoms are not directly connected with each other, one or more H atoms can be independently replaced by F, Cl, or G3, and at least one H atom is replaced by G3;
G3 represents a C1-C7 tertiary alcohol structure; and
X represents —CH₂—, —O—, or —S—.

2. The polymerizable compound according to claim 1, characterized in that the compound represented by formula I is at least one of compounds represented by formulas I-1 to I-41: 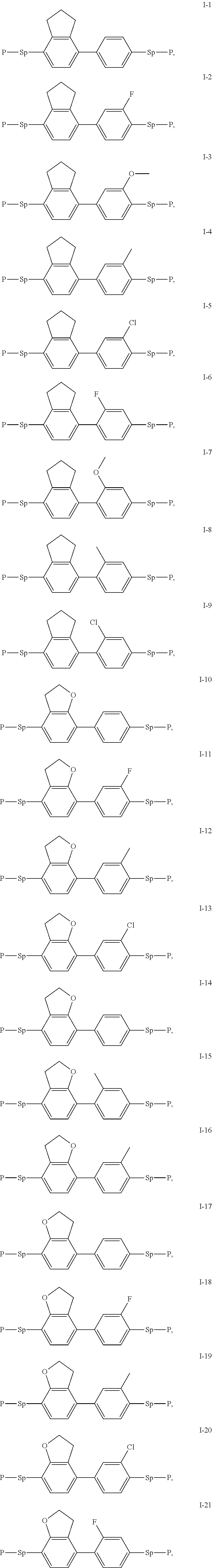 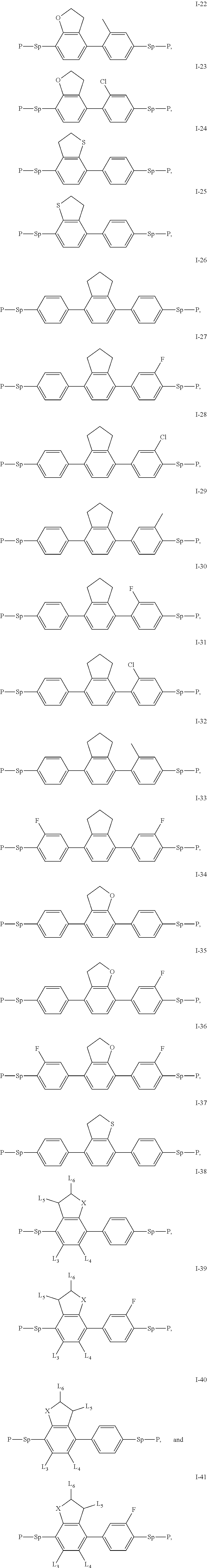
wherein
L₃, L₄, L₅, and L₆ are each independently selected from H, C1-C5 alkyl or alkoxy, C2-C5 alkenyl or alkenoxy, and halogen.

3. The polymerizable compound according to claim 1, characterized in that the compound represented by formula I is at least one of compounds represented by formulas I-1-1 to I-41-5:

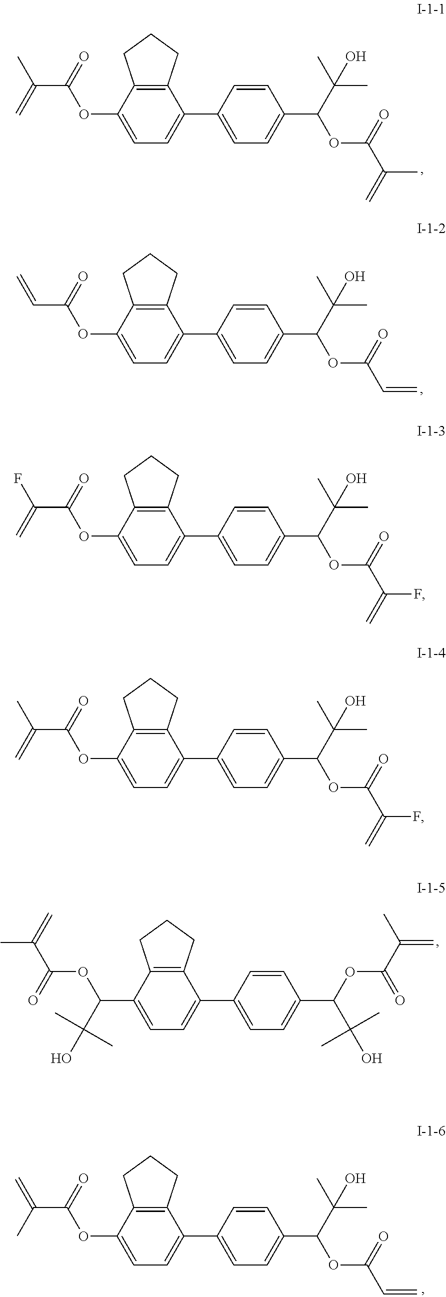

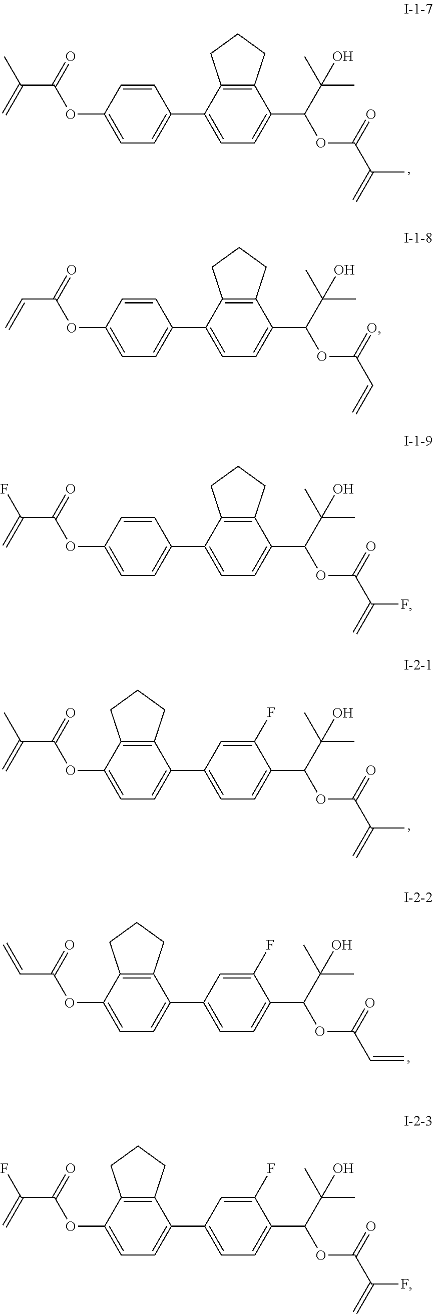

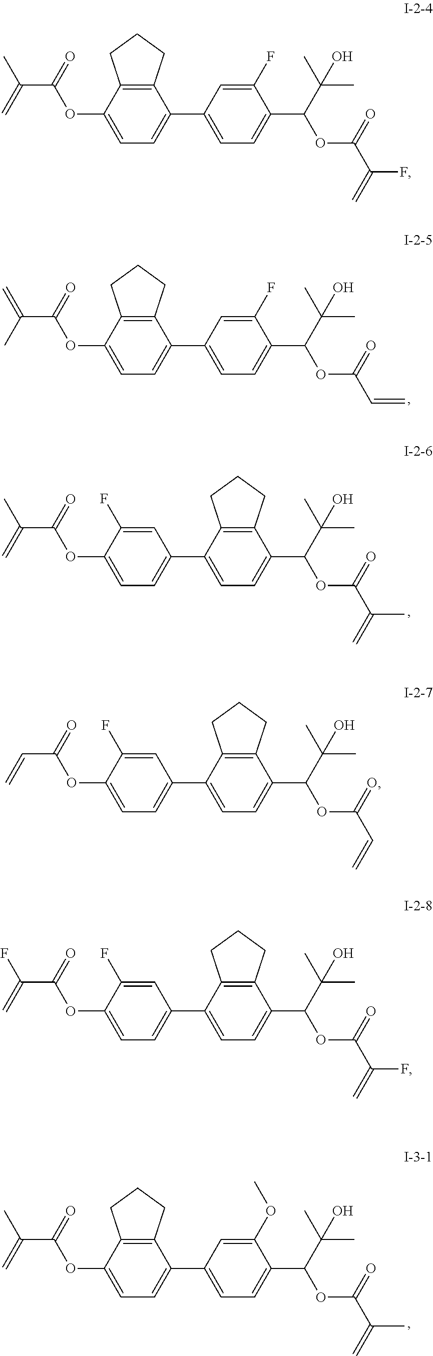

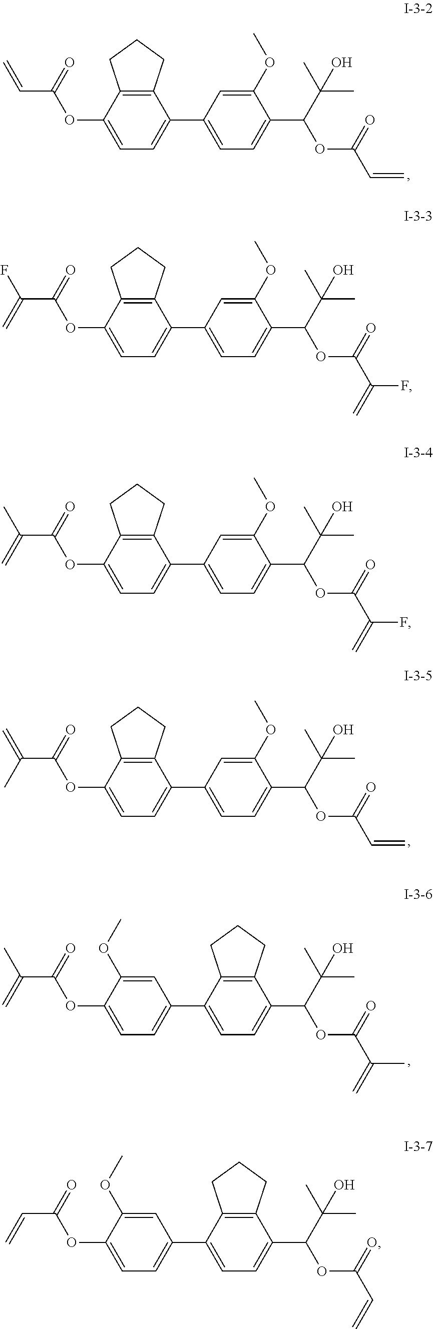

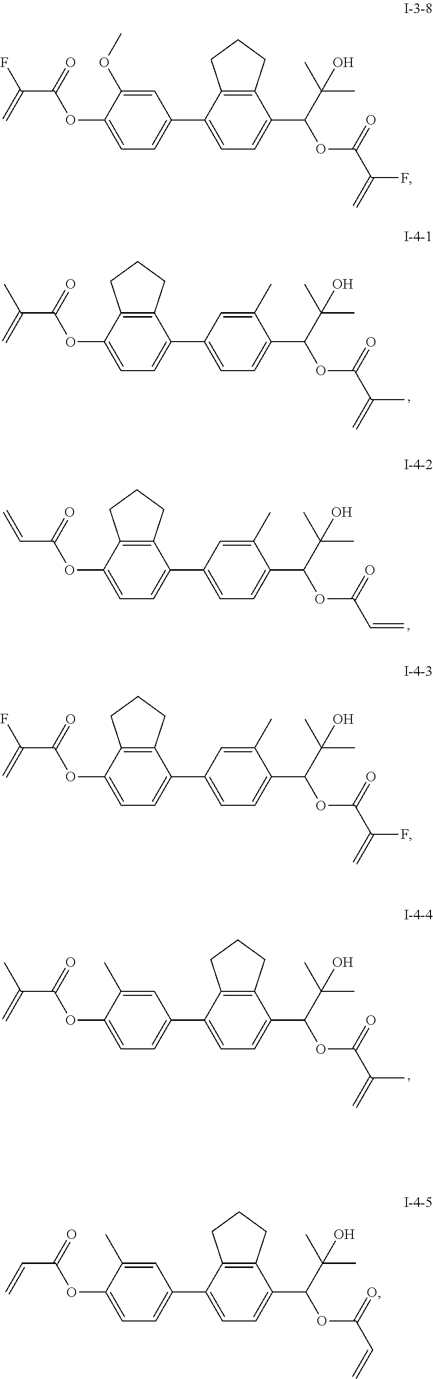

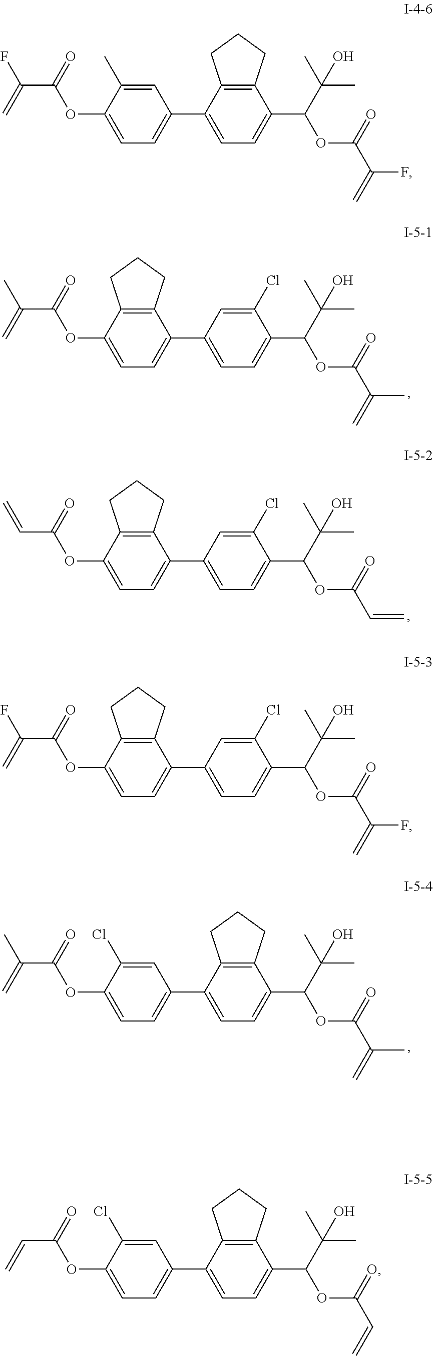

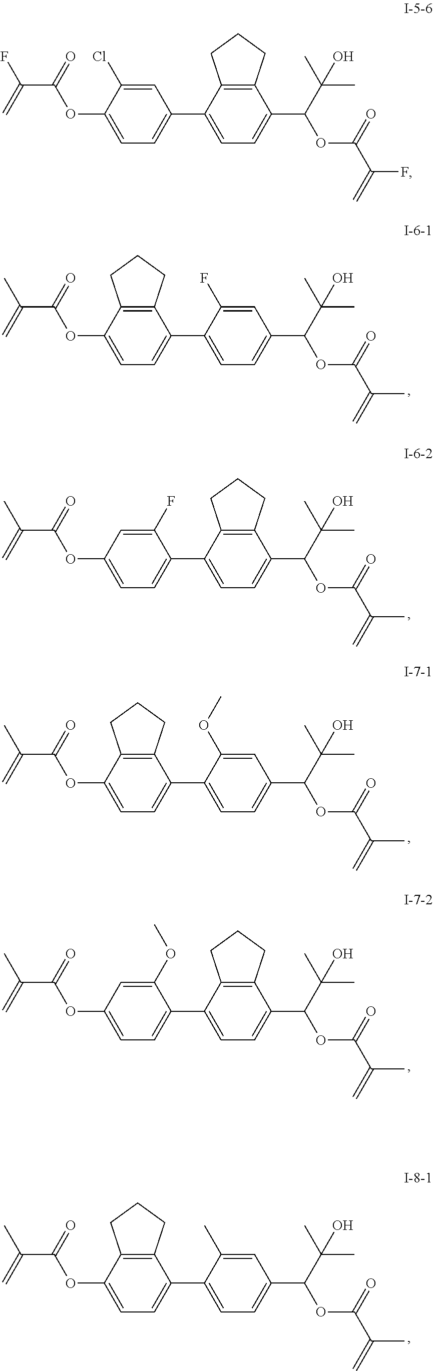

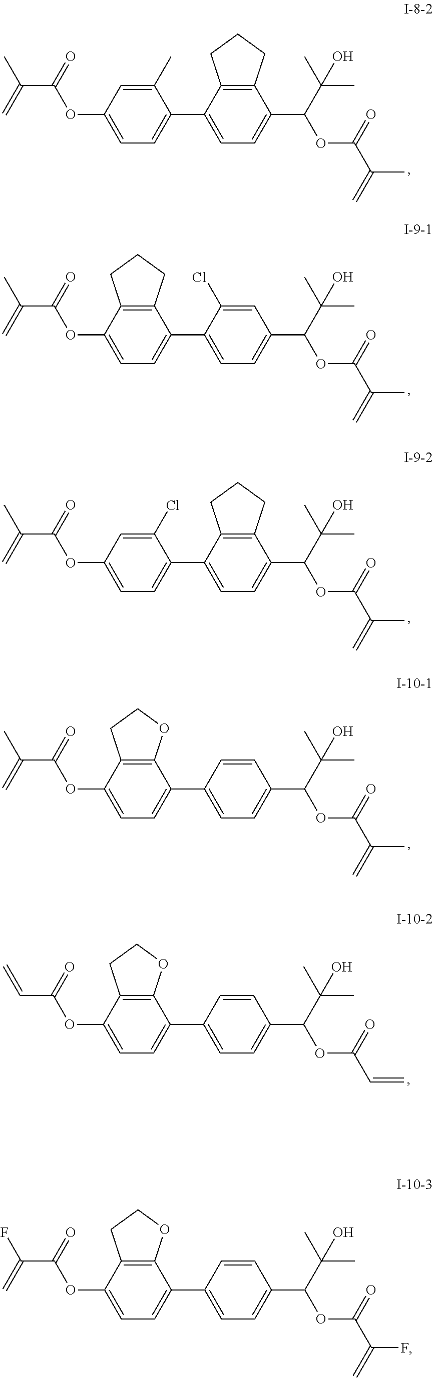

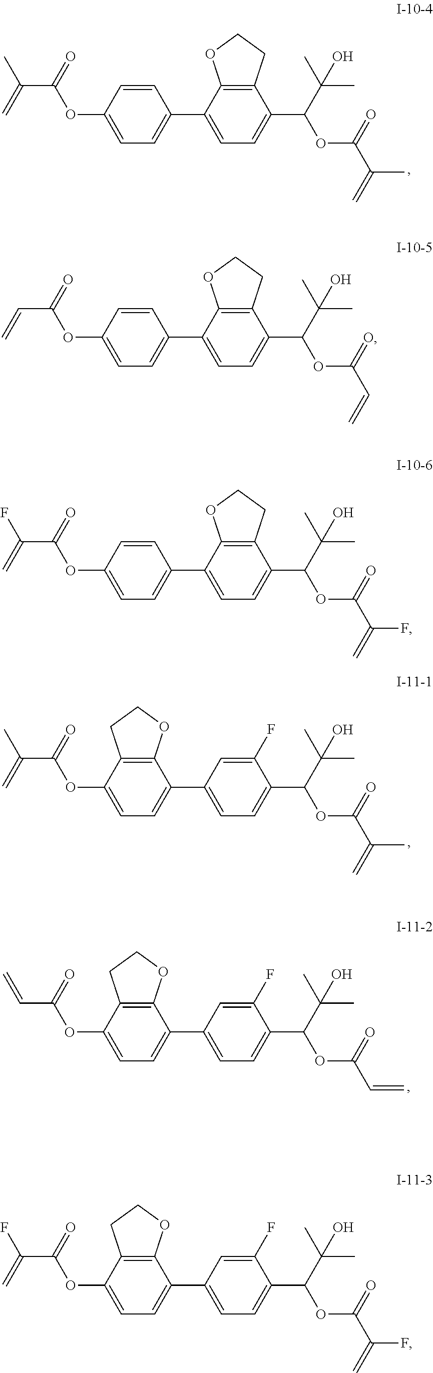

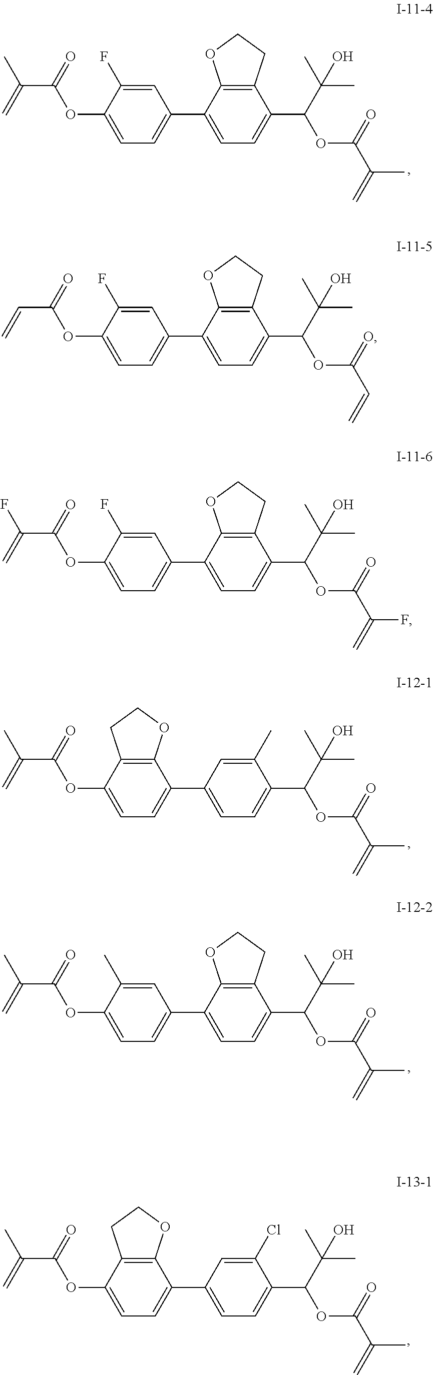

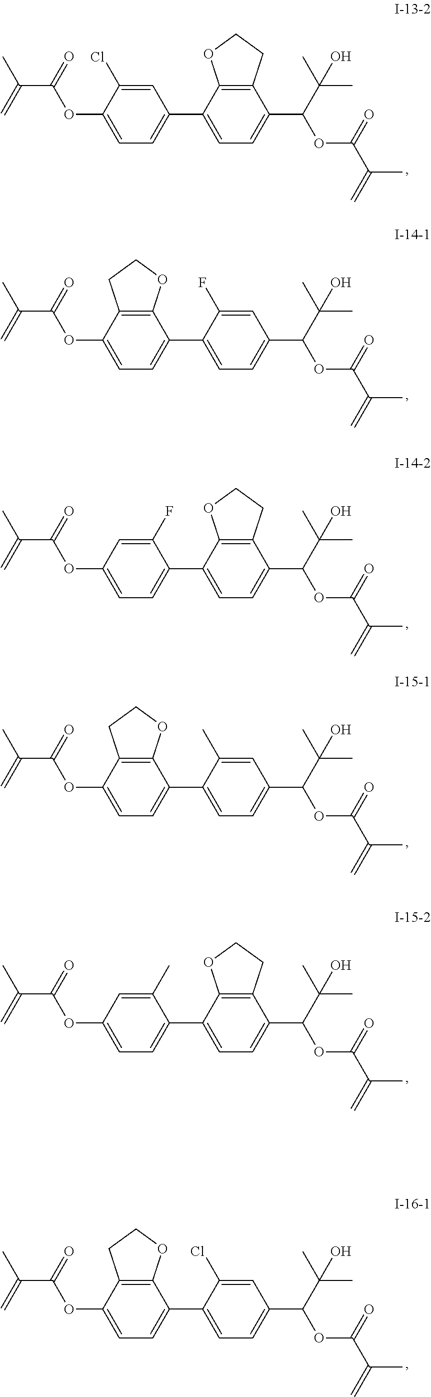

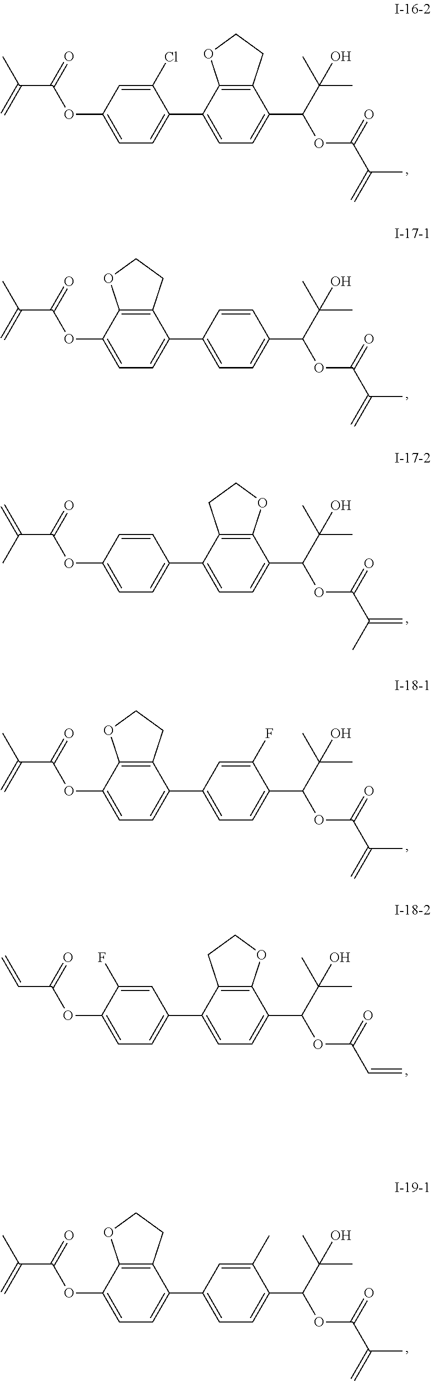

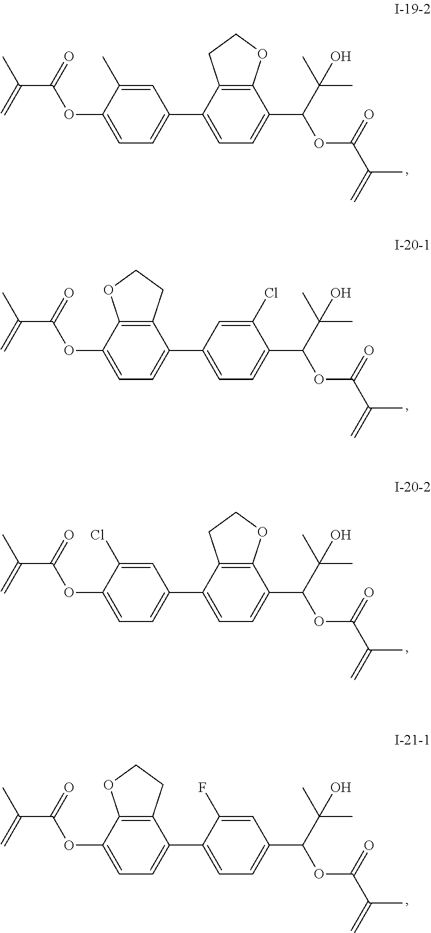

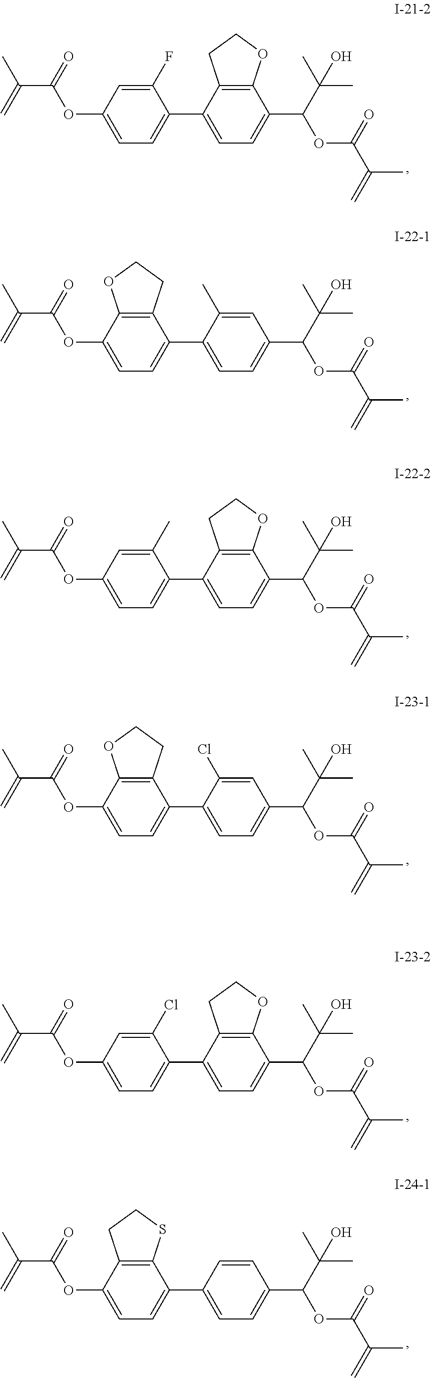

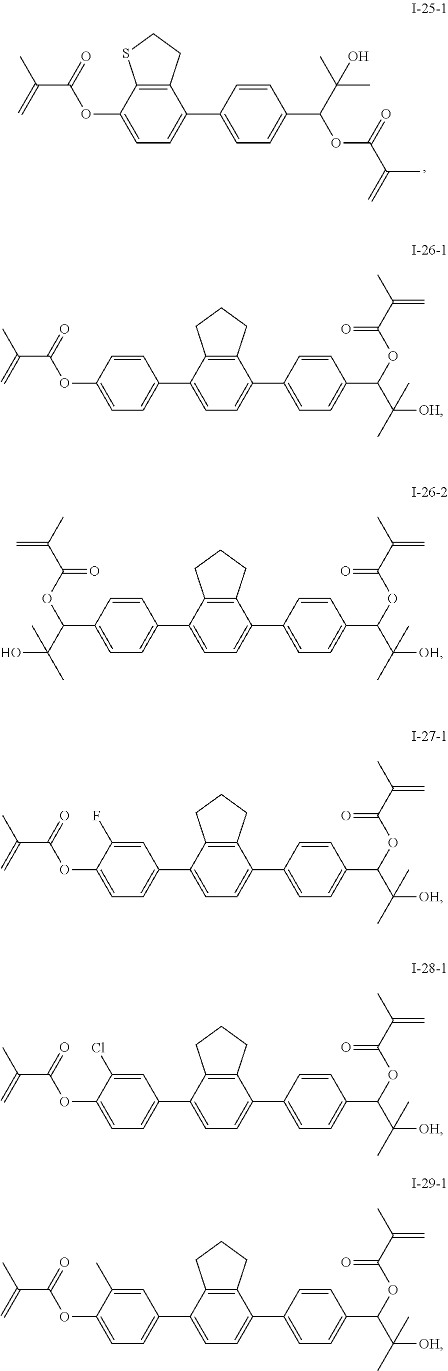

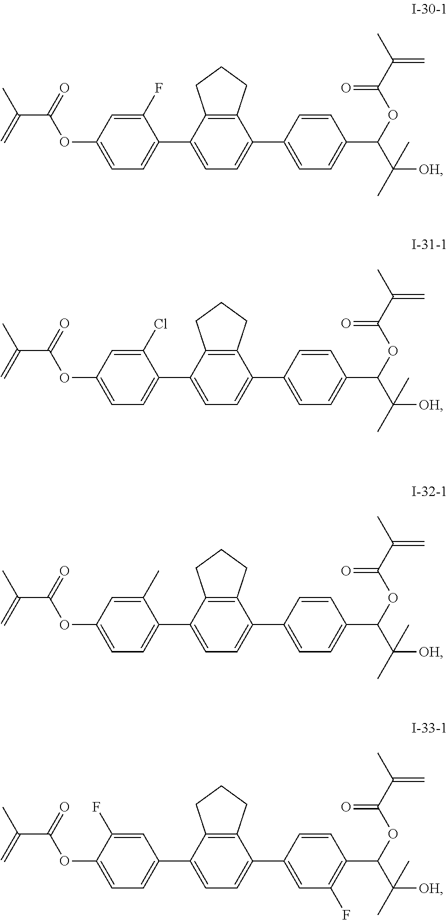 [SMILES: C=C(C)C(=O)Oc1ccc(-c2ccc(-c3ccc(C(OC(=O)C(=C)C)C(C)(C)O)cc3)c3c2CCC3)c(F)c1 ; C=C(C)C(=O)Oc1ccc(-c2ccc(-c3ccc(C(OC(=O)C(=C)C)C(C)(C)O)cc3)c3c2CCC3)c(Cl)c1 ; C=C(C)C(=O)Oc1ccc(-c2ccc(-c3ccc(C(OC(=O)C(=C)C)C(C)(C)O)cc3)c3c2CCC3)c(C)c1 ; C=C(C)C(=O)Oc1ccc(-c2ccc(-c3ccc(C(OC(=O)C(=C)C)C(C)(C)O)c(F)c3)c3c2CCC3)cc1F]

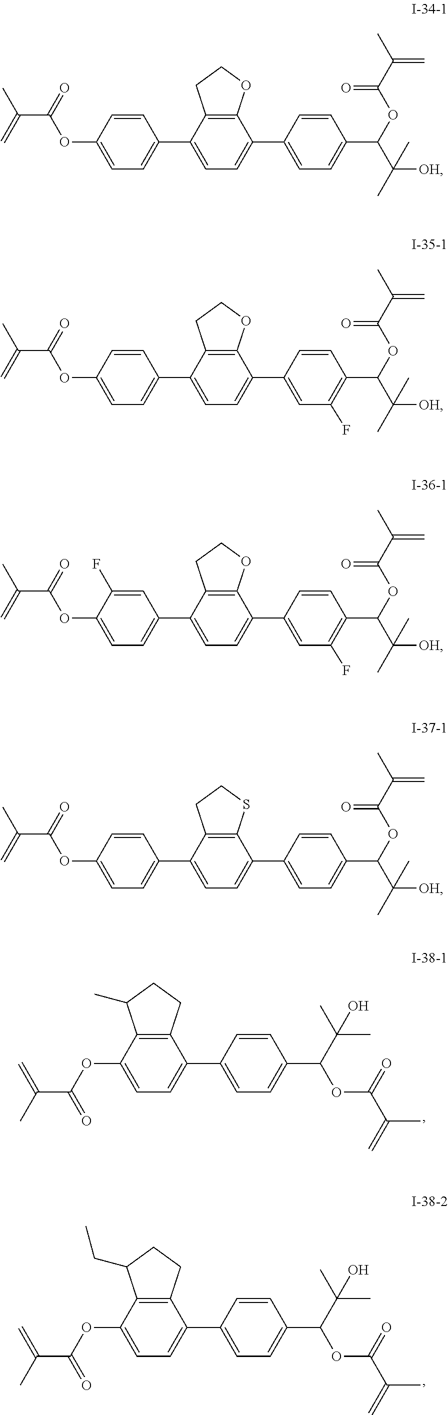

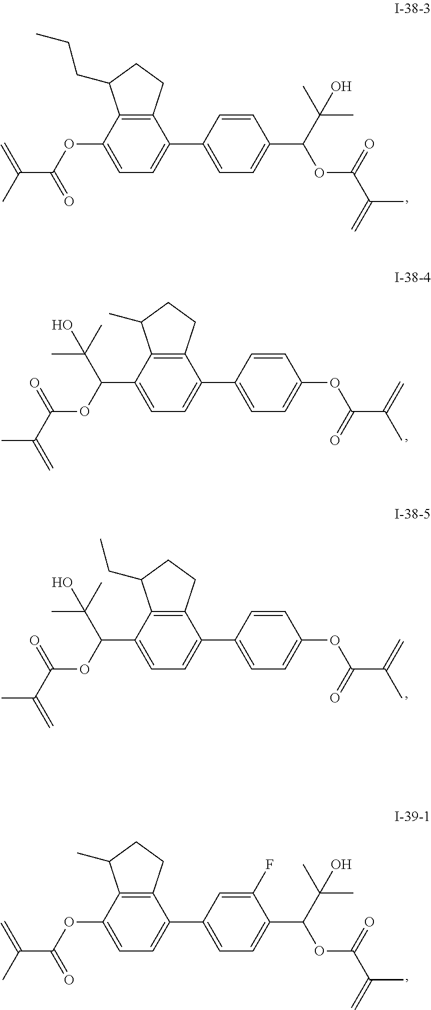

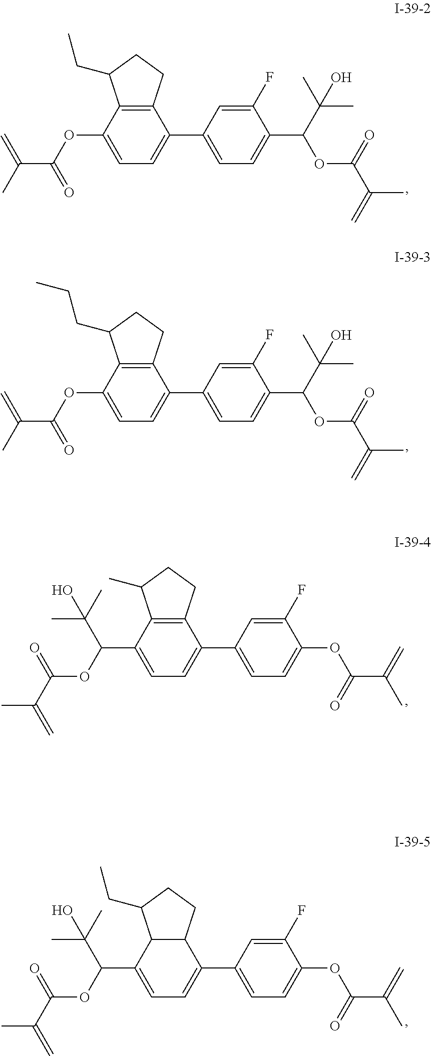

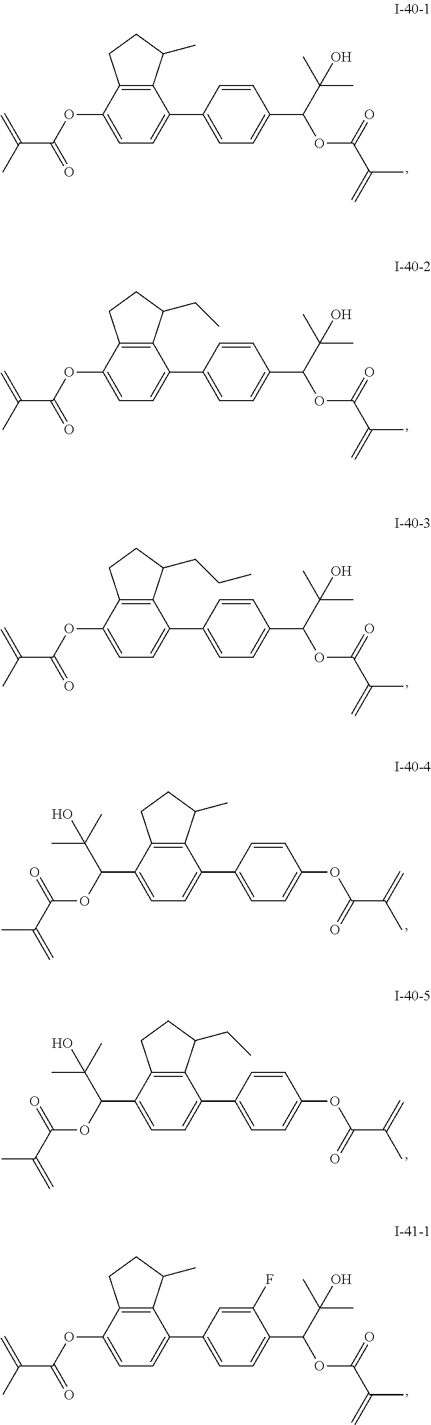

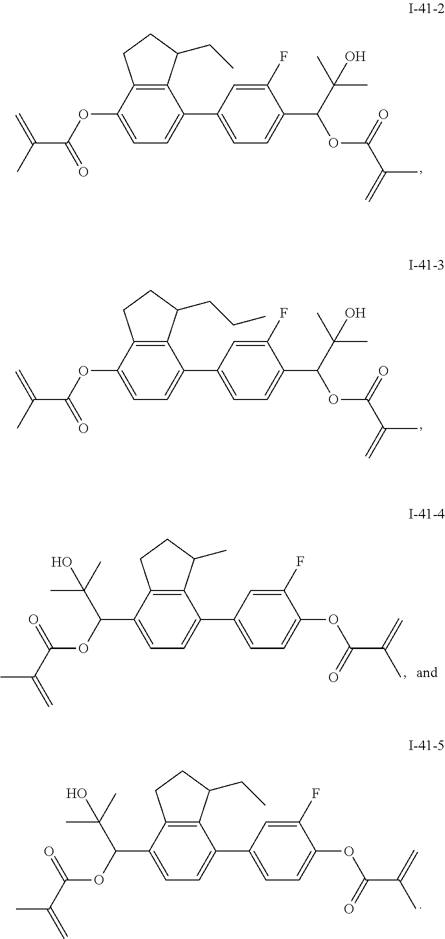

4. A liquid crystal composition, characterized by comprising one or more polymerizable compounds as defined in claim 1 as a first component, one or more compounds represented by formula II as a second component, and one or more compounds represented by formula III as a third component: 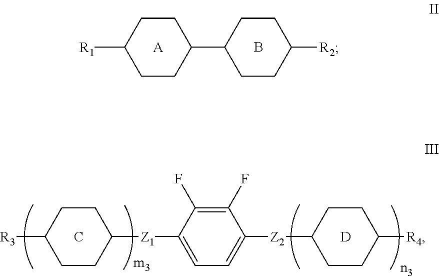
wherein
R₁, R₂, R₃, and R₄ each independently represent C1-C10 alkyl, C1-C10 alkoxy, or C2-C10 alkenyl, wherein one or more non-adjacent —CH₂— can be replaced by cyclopropyl, cyclopentyl, or cyclobutyl;
Z₁ and Z₂ each independently represent —CH₂—CH₂—, —O—, —CO—, —CO—O—, —O—CO—, —CH₂O—, —OCH₂—, —CH═CH—, —CF₂O—, or a single bond; 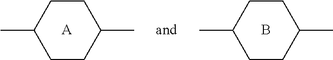
each independently represent 1,4-phenylene, 1,4-cyclohexylidene, or 1,4-cyclohexenylene; 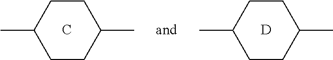
each independently represent 1,4-phenylene, 2,3-difluoro-1,4-phenylene, 2-fluoro-1,4-phenylene, 3-fluoro-1,4-phenylene, trans-1,4-cyclohexylidene, or 1,4-cyclohexenylene, wherein one or two-CH₂— can be replaced by —O—;
m₃ represents 1 or 2; and
n₃ represents 0, 1, or 2.

5. The liquid crystal composition according to claim 4, characterized in that the one or more compounds represented by formula II is one or more compounds of formulas II-1 to II-15: 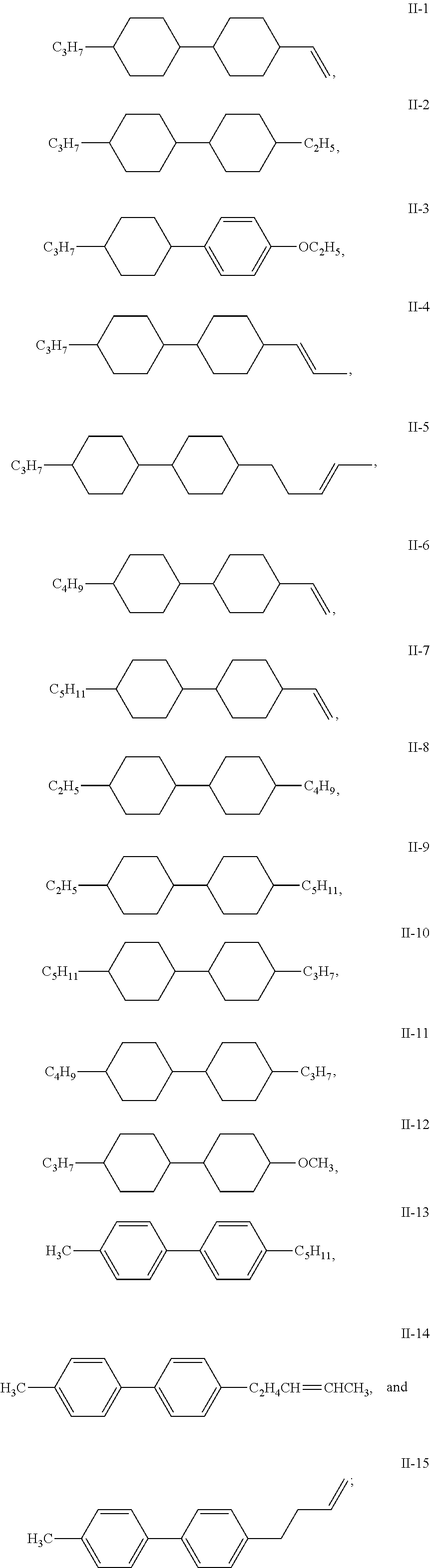
and/or
the one or more compounds represented by formula III is one or more compounds represented by formulas III-1 to III-12: 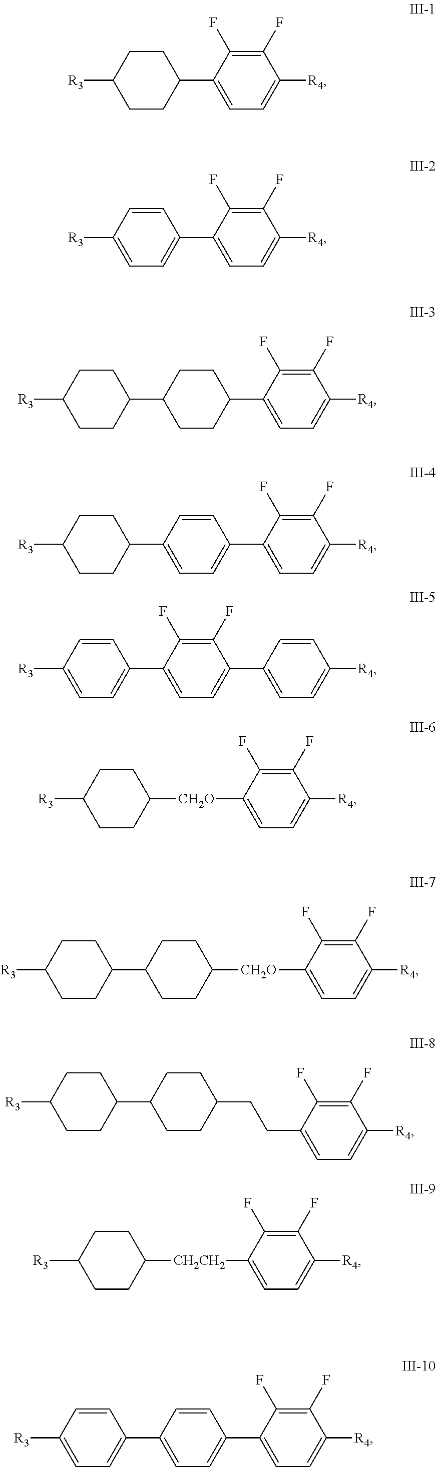 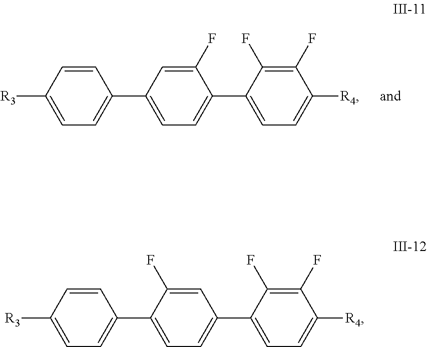
wherein
R₃ and R₄ each independently represent C1-C10 alkyl, C1-C10 alkoxy, or C2-C10 alkenyl, wherein one or more non-adjacent —CH₂— can be replaced by cyclopropyl, cyclopentyl, or cyclobutyl.

6. The liquid crystal composition according to claim 4, characterized in that the liquid crystal composition is a negative liquid crystal composition, and the liquid crystal composition further comprises one or more compounds represented by formula IV: 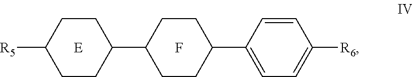
wherein
R₅ and R₆ each independently represent C1-C10 alkyl, fluorine-substituted C1-C10 alkyl, C1-C10 alkoxy, fluorine-substituted C1-C10 alkoxy, C2-C10alkenyl, fluorine-substituted C2-C10 alkenyl, C3-C8 alkenoxy, or fluorine-substituted C3-C8 alkenoxy; 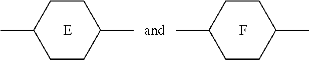
each independently represent 1,4-phenylene, 1,4-cyclohexylidene, or 1,4-cyclohexenylene; and/or
the liquid crystal composition further comprises one or more compounds represented by formula V: 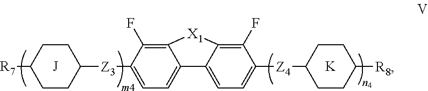
wherein
R₇ and R₈ each independently represent an H atom, halogen, C1-C10 alkyl, C1-C10 fluoroalkyl, C1-C10 alkoxy, or C1-C10 fluoroalkoxy, and any one or more CH₂ in the groups represented by R₇ and R& can be replaced by cyclopentyl, cyclobutyl, or cyclopropyl;
X₁ represents —O—, —S—, —CO—, or —CH₂O—;
Z₃ and Z₄ each independently represent —O—, —CO—, —CO—O—, —O—CO—, —CH₂O—, —OCH₂—, —CH═CH—, —CF₂O—, or a single bond; 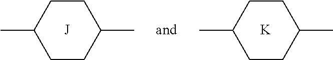
each independently represent cyclopropyl, cyclobutyl, cyclopentyl, 1,4-phenylene, 2,3-difluoro-1,4-phenylene, 2-fluoro-1,4-phenylene, 3-fluoro-1,4-phenylene, trans-1,4-cyclohexylidene, or 1,4-cyclohexenylene;
m₄ represents 0, 1, or 2; and
n₄ represents 0, 1, or 2.

7. The liquid crystal composition according to claim 4, characterized in that the liquid crystal composition is a negative liquid crystal composition, and the liquid crystal composition further comprises one or more compounds represented by formula VI: 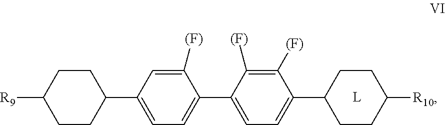
wherein
R₉ and R₁₀ each independently represent C1-C10 alkyl, fluorine-substituted C1-C10 alkyl, C1-C10 alkoxy, fluorine-substituted C1-C10 alkoxy, C2-C10alkenyl, fluorine-substituted C2-C10 alkenyl, C3-C8 alkenoxy, or fluorine-substituted C3-C8 alkenoxy; 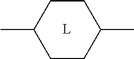
represents 1,4-phenylene, 1,4-cyclohexylidene, or 1,4-cyclohexenylene; and
each occurrence of (F) independently represents H or F.

8. The liquid crystal composition according to claim 4, characterized in that in the liquid crystal composition, the total mass percentage content of the compounds represented by formula I is 0.01-1%, the total mass percentage content of the compounds represented by formula II is 15-60%, and the total mass percentage content of the compounds represented by formula III is 20-80%.

9. A liquid crystal display device, characterized by comprising the liquid crystal composition according to claim 4.

10. The liquid crystal display device according to claim 9, characterized in that the liquid crystal display device is a PSVA or SAVA display.
